(19) United States
(12) Patent Application Publication
(10) Pub. No.: US 2024/0160663 A1
(43) Pub. Date: May 16, 2024

(54) System, Process, and Method for Matching Users Based on Photos

(71) Applicant: Hunch Social, LLC, New York, NY (US)

(72) Inventors: See Gwan Ho, New York, NY (US); Eric Walter Chang, New York, NY (US)

(21) Appl. No.: 18/373,800

(22) Filed: Sep. 27, 2023

Related U.S. Application Data
(60) Provisional application No. 63/425,977, filed on Nov. 16, 2022.

(51) Int. Cl. G06F 16/58; G06F 16/583

(52) U.S. Cl. CPC G06F 16/5866; G06F 16/583

(57) ABSTRACT

Methods, systems, and apparatuses are described herein for providing a user matching system that matches users based on interests represented in images. A user might upload a first image. Based on determining that the image does not contain human faces, the computing device may determine first keywords associated with the first image. The user might be presented a profile of a second user based on a comparison of the first keywords and second keywords associated with the profile of the second user. Those second keywords might also have been determined by processing second images of the profile of the second user. Each user's profile may be represented as a collage of interest images without containing images of the user, thereby preserving privacy and focusing users on non-superficial topics.

### FIELD OF USE

Aspects of the disclosure relate generally to social media applications, including matching, networking, and social services such as dating software applications. More particularly, aspects of the disclosure relate to matching users based on keywords generated based on photos uploaded by those users.

### BACKGROUND

There are currently are over 1,500 online dating sites and/or apps. None are perceived as “having the answer,” and it is suggested that there is a high level of dissatisfaction with existing dating sites. While some believe that on-line dating is simply a matter of matching supply and demand, there is statistical and empirical evidence to suggest that successful on-line dating entails far more. However, effectively linking two participants together can prove to be a challenging endeavor. Coordinating a relationship between two like-minded individuals can be a significant chore, as there are a number of obstacles and barriers that must be overcome. One problem is that recommendations and matches by these services contain many irrelevant entities to the user. This costs the user of the service time and may deter them from continuing through all of the recommendations and matches. Another problem that has arisen is that dating applications have used textual submissions (such as in user profiles) to determine recommendations and matches. Users, though, often evaluate others for potential matching using other criteria that cannot be easily captured by textual submission. Yet another problem is that dating applications typically use profile photos that highlight physical features of users. This encourages superficial connections based on physical attraction which are less than meaningful and lead to short-lived connections. Moreover, to any extent that such applications purport to limit what types of photos are uploaded by users (e.g., trying to prevent the uploading of salacious content), users have unfortunately become quite adept at circumventing those restrictions.

### SUMMARY

The following presents a simplified summary of various aspects described herein. This summary is not an extensive overview, and is not intended to identify key or critical elements or to delineate the scope of the claims. The following summary merely presents some concepts in a simplified form as an introductory prelude to the more detailed description provided below.

Aspects described herein relate to providing a user matching system that matches users on non-superficial concepts such as user interests evinced by keywords generated based on images, rather than user attractiveness. User profiles may comprise one or more images that represent interests of the users. For example, a user might upload a photo from a golf course to represent their interest in golf, a photo of a car to represent their interest in cars, and a photograph of a video game console to represent their interest in video games. These images, once processed to ensure that they do not contain impermissible content such as human faces, may be processed to identify keywords associated with each image. Such images may then be collected into a collage of images, which might represent a user as part of a user profile. Then, as part of a potential matching process, users might be presented with similar user profiles based on a comparison of keywords associated with their profile (e.g., associated with the images of their user profile) and keywords associated with other user profiles (e.g., other images). In some circumstances, users might be provided multiple instances to match together: for example, a user might be presented different photos from the same user profile at different times, providing them multiple different opportunities to match with the same user based on different interests. Once matched, discussion prompts might be automatically generated based on those keywords. The result is a social media application (e.g., a dating application) that matches users based on their interests expressed via images without requiring those users to type out profiles and without encouraging users to match on superficial concepts such as physical attractiveness.

More particularly, a computing device may receive a first image to be associated with a first user profile corresponding to a first user and process, using an object recognition algorithm, the first image to identify one or more objects in the first image. Based on determining that the first image does not contain any human faces, the computing device may determine, based on the one or more objects in the first image, one or more first keywords and then store, as part of the first user profile, the first image and the one or more first keywords. The computing device may then query, based on the one or more first keywords, a database to identify one or more second keywords associated with a second user profile corresponding to a second user and display, in a user interface, a second image associated with the second user profile. Then, based on receiving user input associated with the second image, the computing device may instantiate a communications session between the first user and second user and cause display of a third image associated with the second user profile. For example, the second user profile might be displayed as a collage of images associated with the second user profile, such that the user input associated with the second image comprises a swiping touch input associated with the collage of images.

The computing device may be configured to block certain images, such as images of a human face, images sufficiently similar to already-uploaded images, and/or publicly-available images from being added to a user profile. For example, the computing device may receive a fourth image to be associated with the first user profile corresponding to the first user, process, using the object recognition algorithm, the fourth image to identify one or more second objects in the fourth image, and, based on determining that a similarity between the one or more objects and the one or more second objects satisfies a threshold, the computing device may cause output, in the user interface, of a notification that the fourth image will not be added to the first user profile. As another example, the computing device may receive a fourth image to be associated with the first user profile corresponding to the first user, process, using a facial image recognition algorithm, the fourth image, and, based on determining that the first image contains at least one human face, the computing device may cause output, in the user interface, of a notification that the fourth image will not be added to the first user profile. As another example, the computing device may receive a fourth image to be associated with the first user profile corresponding to the first user, send the fourth image to a reverse image search engine, and based on receiving, from the reverse image search engine, an indication that the fourth image has been uploaded on a website, cause output, in the user interface, of a notification that the fourth image will not be added to the first user profile.

Keywords may be used to create discussion prompts. For example, the computing device may generate, based on the one or more first keywords and the one or more second keywords, a discussion prompt for the first user and the second user and cause display, in the user interface, of the discussion prompt.

Corresponding methods, apparatus, systems, and non-transitory computer-readable media are also within the scope of the disclosure.

These features, along with many others, are discussed in greater detail below.

### BRIEF DESCRIPTION OF THE DRAWINGS

The present disclosure is illustrated by way of example and not limited in the accompanying figures in which like reference numerals indicate similar elements and in which:

FIG. 1 depicts a computing device that may be used to implement aspects described herein.

FIG. 2 depicts a system for providing a social media application.

FIG. 3 depicts a flow chart with steps for implementing a social media application.

FIG. 4 depicts a system for providing a photo-based matching social media application.

FIG. 5 depicts a flowchart illustrating an example process for the photo processing engine.

FIG. 6 depicts an illustrative user profile.

FIG. 7A shows a social media application user interface depicting a profile.

FIG. 7B shows a social media application user interface depicting a notification preventing uploading of a photo with a face.

FIG. 7C shows a social media application user interface depicting a notification preventing uploading of a photo too similar to previously-uploaded photos.

FIG. 7D shows a social media application user interface depicting a notification preventing uploading of a stock photo.

FIG. 7E shows a social media application user interface depicting a notification preventing uploading of a photo including embedded words.

FIG. 7F shows a social media application user interface depicting a notification preventing uploading of too many photos.

FIG. 7G shows a social media application user profile editing user interface.

FIG. 7H shows a social media application user interface depicting a second user's profile, with a particular focus on a single image.

FIG. 7I shows a social media application user interface depicting a second user's profile as a collage of all their images.

FIG. 7J shows a social media application matches listing.

FIG. 7K shows a social media application user interface depicting a communications session between two users.

FIG. 7L shows a social media application user interface depicting a notification preventing a user from sending photos to another user within a predetermined period of time.

FIG. 7M shows a social media application user interface depicting a set of options for a first user.

FIG. 7N shows a social media application user interface depicting a communications session between two users, following a first user's request to send photos to a second user.

FIG. 7O shows a social media application user interface depicting a set of options for a first user, following the first user's request to send photos to a second user.

FIG. 7P shows a social media application user interface depicting a communications session between two users, following a second user reciprocating a first user's request to send photos.

FIG. 7Q shows a social media application user interface depicting a communications session between two users, following a second user's request to send photos to a first user.

FIG. 7R shows a social media application user interface depicting a set of options for a first user, following a second user's request to send photos to the first user.

FIG. 7S shows a social media application user interface depicting a communications session between two users, following a first user reciprocating a second user's request to send photos; and the second user subsequently and for the first time sending a photo depicting her facial appearance.

FIG. 7T shows a social media application user interface depicting keywords and statistics for a particular image.

FIG. 7U shows a social media application user interface depicting global statistics for a particular user.

FIG. 8 depicts an illustrative flowchart showing an example of a first user navigating the social media application and receiving images associated with other users.

### DETAILED DESCRIPTION

In the following description of the various embodiments, reference is made to the accompanying drawings, which form a part hereof, and in which is shown by way of illustration various embodiments in which aspects of the disclosure may be practiced. It is to be understood that other embodiments may be utilized and structural and functional modifications may be made without departing from the scope of the present disclosure. Aspects of the disclosure are capable of other embodiments and of being practiced or being carried out in various ways. Also, it is to be understood that the phraseology and terminology used herein are for the purpose of description and should not be regarded as limiting. Rather, the phrases and terms used herein are to be given their broadest interpretation and meaning. The use of “including” and “comprising” and variations thereof is meant to encompass the items listed thereafter and equivalents thereof as well as additional items and equivalents thereof.

Typically, in matching, networking, and social services, for example an online dating service, users will be prompted to upload profile photos of themselves which typically include their physical features such as their faces. This poses numerous problems. Such interest-based profile photos which include users' physical features encourage superficial connections skewed towards physical attraction. Some individuals may decide whether or not to message another user based solely on physical attraction without meaningfully evaluating other information related to other users. In the dating context, this may be problematic as such superficial connections may be shorter lasting than connections based on more meaningful attributes. Even when such a service includes insight into other attributes of a user, profile photos depicting users' physical features nonetheless may gatekeep a meaningful connection based on those other attributes. Further, users with the most attractive physical features are oftentimes the ones that receive the most attention. If the users with less attractive physical features cease to use the system as a result of lack of attention, the quality of the user pool deteriorates. Furthermore, some users might not want to include profile photos with their physical features due to privacy concerns. In such a service where having profile photos with a user's physical feature is the norm, users who do not upload profile photos with their physical features is viewed as unusual and does not garner attention. Furthermore, such profile photos based on physical features are often modified, outdated, or completely false. This phenomenon of deceiving people with faulty profile pictures has led to the coining of the term “catfish,” which is now a common term used to describe such online scenarios where someone fabricates an online identity to deceive others. As a result, the users of such systems are often unsatisfied with these systems.

Further, in many cases, a user is not aware of the interests of the other person. In some services, users are required to generate a profile page. In that profile page, characteristics of the user are described textually and displayed; however, these textual descriptions do not maximize the real behavioral and emotional components of what a user may find attractive or unattractive among the interests of other members in the dating website. There are useful information that are not easily described textually or there are nuances to a user's interest that cannot be described in short sentences, and therefore lost, in conventional matching methods. For example, a user may describe that he enjoys walks on the beach, but this doesn't capture more nuanced aspects such as the kind of beach or the time of the day preferred for the walks. Losing these nuances prevents users from really getting a sense of who another user is as a person and how the two would interact. As a result, the users of such systems are often unsatisfied with these matchmaking systems.

To facilitate genuine connections, it may be desirable to connect different users of an application based on their personality and interests, rather than their physical looks. That said, merely asking users to list their interests in a textual profile has caveats: users might still prioritize physical attractiveness in images, users might actively lie about their interests (e.g., pretend to be more athletic than they really are), users might abuse the textual profile to market other social media profiles, or the like. To provide such a matching system while still preventing unintentional or intentional manipulation, aspects described herein provide for a matching system that allows users to upload a collage of their images that show their hobbies and interests, rather than their looks. For example, a user might upload photos from their recent hike to show their interest in hiking, might upload a photo of their computer to show an interest in video games, or the like. To prevent users from trying to circumvent this matching process, various algorithms may be used to prevent users from uploading photographs of their face (which might reveal their physical attractiveness), photographs from public sources such as online databases (as they might not accurately reflect the user's interests), and photos that are too similar to photos already uploaded by the user (to ensure that the profile is sufficiently diverse and reflective of a variety of user interests, rather than simply depicting the same or similar objects). Moreover, and as will be described in further detail below, users might be matched based on keywords determined based on the images. This ensures that users can be matched based on their interests as expressed pictorially without disclosing the physical attractiveness of the user until desired.

As an example of how the present disclosure may operate, a user might make a user profile by uploading five different photos: a photo from their recent hike, a photo of their computer, a photo of running shoes, a photo of their cat, and a photo from a recent trip. Based on determining that the images do not contain any human faces, a computing device may process the images to identify objects in the images, then store keywords (e.g., “hiking,” “computers,” “gaming,” “running,” “walking,” “cats,” “animals,” “travel”) to their user profile. That user may be matched based on those keywords in a variety of ways (e.g., by querying a database to identify other users with a user profile associated with the “travel” keyword). A user might be then provided an opportunity to instantiate a communications session with other user(s), and that opportunity might comprise an opportunity to see a photograph of the other user(s). In some circumstances, users might be provided different photographs from the same profile at different times, providing them multiple different opportunities to connect with the same user. Once connected, a discussion prompt might be generated based on the “travel” keyword (e.g., “Where did you last travel?”), encouraging both users to naturally start a conversation based on a shared interest.

Aspects described herein act as a significant improvement to the security and functionality of social media applications. As indicated above, it may be desirable to match users based on their interests, but users can be quite clever at circumventing restrictions imposed by apps. For example, many existing social media applications are plagued with fake images, textual promotions of other social media applications, uploads of salacious content, and the like. This is, in part, because manual review of user profiles is prohibitively time-consuming and difficult. As a result, social media applications can perform poorly, be less used by users, and can generally be exploited by users in undesired ways. For instance, such applications can devolve into proverbial “meat markets,” whereby physical attractiveness is prioritized over personality, because current technology does not have the ability to prevent users from prioritizing such activity. Aspects described herein address these and other problems by using unique computer algorithms (e.g., object recognition algorithms, facial recognition algorithms, search processes of publicly-available image databases). For example, interest-based profile photos representing interests of users allow users to interact and engage with each other more meaningfully and decreases the processing and bandwidth resources expended by users gathering and reviewing information about another user. Users may be more likely to evaluate each other based on substantive characteristics rather than superficial characteristics such as attractiveness. Further, interest-based profile photos representing interests of corresponding users may be a useful way to stimulate engaging conversations. In turn, the present disclosure makes social media applications operate better, more quickly, and more desirably.

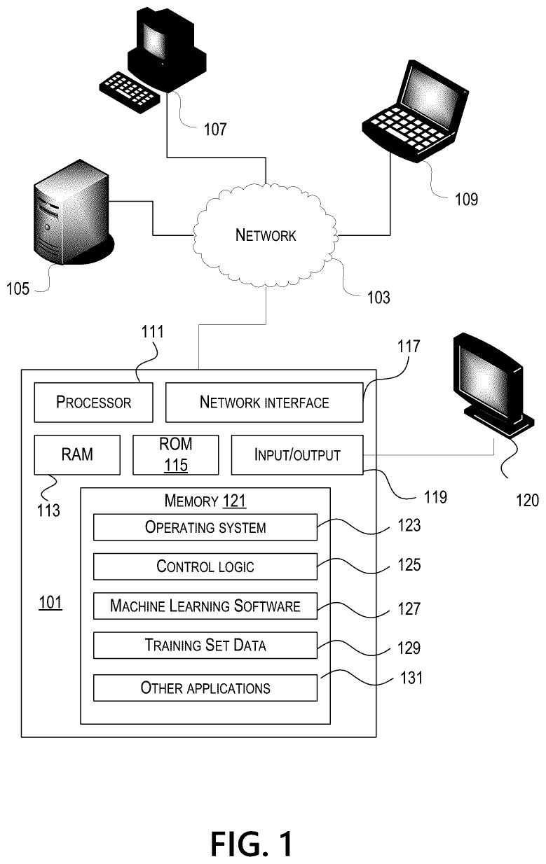

Before discussing these concepts in greater detail, however, several examples of a computing device that may be used in implementing and/or otherwise providing various aspects of the disclosure will first be discussed with respect to FIG. 1.

FIG. 1 illustrates one example of a computing device 101 that may be used to implement one or more illustrative aspects discussed herein. For example, computing device 101 may implement one or more aspects of the disclosure by reading and/or executing instructions and performing one or more actions based on the instructions. The computing device 101 may represent, be incorporated in, and/or include various devices such as a desktop computer, a computer server, a mobile device (e.g., a laptop computer, a tablet computer, a smart phone, any other types of mobile computing devices, and the like), and/or any other type of data processing device.

Computing device 101 may operate in a standalone environment. In others, computing device 101 may operate in a networked environment. As shown in FIG. 1, computing devices 101, 105, 107, and 109 may be interconnected via a network 103, such as the Internet. Other networks may also or alternatively be used, including private intranets, corporate networks, LANs, wireless networks, personal networks (PAN), and the like. Network 103 is for illustration purposes and may be replaced with fewer or additional computer networks. A local area network (LAN) may have one or more of any known LAN topologies and may use one or more of a variety of different protocols, such as Ethernet. Devices 101, 105, 107, 109 and other devices (not shown) may be connected to one or more of the networks via twisted pair wires, coaxial cable, fiber optics, radio waves or other communication media.

As seen in FIG. 1, computing device 101 may include a processor 111, RAM 113, ROM 115, network interface 117, input/output interfaces 119 (e.g., keyboard, mouse, display, printer, etc.), and memory 121. Processor 111 may include one or more computer processing units (CPUs), graphical processing units (GPUs), and/or other processing units such as a processor adapted to perform computations associated with machine learning. I/O 119 may include a variety of interface units and drives for reading, writing, displaying, and/or printing data or files. I/O 119 may be coupled with a display such as display 120. Memory 121 may store software for configuring computing device 101 into a special purpose computing device in order to perform one or more of the various functions discussed herein. Memory 121 may store operating system software 123 for controlling overall operation of computing device 101, control logic 125 for instructing computing device 101 to perform aspects discussed herein, machine learning software 127, training set data 129, and other applications 131. Control logic 125 may be incorporated in and may be a part of machine learning software 127. In some circumstances, computing device 101 may include two or more of any and/or all of these components (e.g., two or more processors, two or more memories, etc.) and/or other components and/or subsystems not illustrated here.

Devices 105, 107, 109 may have similar or different architecture as described with respect to computing device 101. Those of skill in the art will appreciate that the functionality of computing device 101 (or device 105, 107, 109) as described herein may be spread across multiple data processing devices, for example, to distribute processing load across multiple computers, to segregate transactions based on geographic location, user access level, quality of service (QoS), etc. For example, computing devices 101, 105, 107, 109, and others may operate in concert to provide parallel computing features in support of the operation of control logic 125 and/or machine learning software 127.

One or more aspects discussed herein may be embodied in computer-usable or readable data and/or computer-executable instructions, such as in one or more program modules, executed by one or more computers or other devices as described herein. Generally, program modules include routines, programs, objects, components, data structures, etc. that perform particular tasks or implement particular abstract data types when executed by a processor in a computer or other device. The modules may be written in a source code programming language that is subsequently compiled for execution, or may be written in a scripting language such as (but not limited to) HTML or XML. The computer executable instructions may be stored on a computer readable medium such as a hard disk, optical disk, removable storage media, solid state memory, RAM, etc. As will be appreciated by one of skill in the art, the functionality of the program modules may be combined or distributed as desired in various embodiments. In addition, the functionality may be embodied in whole or in part in firmware or hardware equivalents such as integrated circuits, field programmable gate arrays (FPGA), and the like. Particular data structures may be used to more effectively implement one or more aspects discussed herein, and such data structures are contemplated within the scope of computer executable instructions and computer-usable data described herein. Various aspects discussed herein may be embodied as a method, a computing device, a data processing system, or a computer program product.

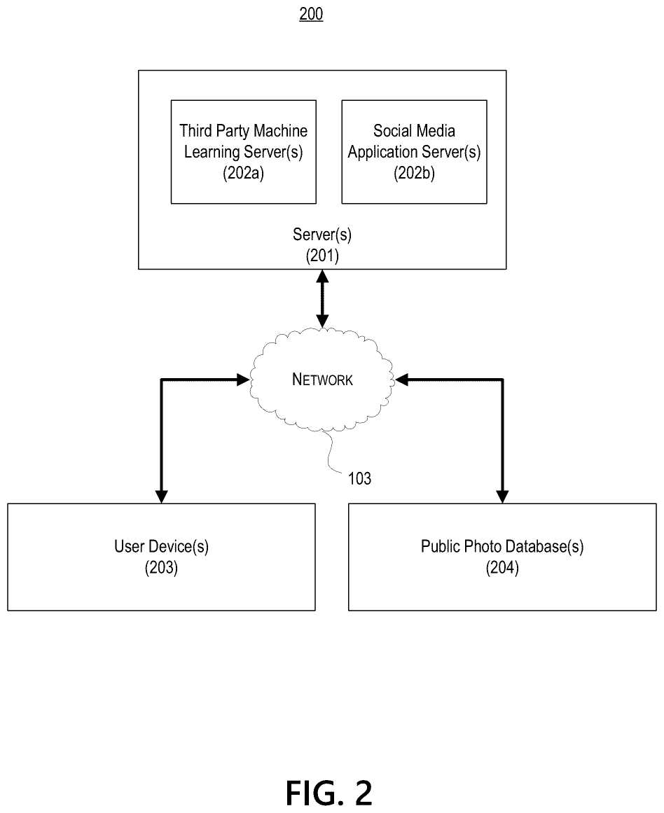

FIG. 2 depicts a system 200 comprising one or more servers 201 (that include one or more third-party servers 202a and one or more social media application servers 202b) communicatively coupled, via the network 103, to one or more user devices 203 and one or more public photo databases 204. The one or more servers 201, the one or more user devices 203, and/or the one or more public photo databases 204 may comprise computing devices, such as computing devices that comprise one or more processors and memory storing instructions that, when executed on the one or more processors, cause the performance of one or more steps. The one or more servers 201, the one or more user devices 203, and/or the one or more public photo databases 204 may comprise any of the devices depicted with respect to FIG. 1, such as one or more of the computing devices 101, 105, 107, and/or 109.

The one or more social media application servers 202b may comprise one or more servers configured to facilitate one or more social media applications that may execute on the one or more user devices 203. For example, the one or more social media application servers 202b may receive images uploaded by users, process those images using one or more algorithms (e.g., object recognition algorithms, facial recognition algorithms, machine learning models), search for those images via the one or more public photo databases 204, determine keywords for images, associate keywords with user profiles, store user profiles and/or keywords, search for user profiles based on keywords, match users based on keywords, and the like.

The one or more third-party servers 202a may be configured to perform steps such as outputting keywords based on images. The third-party servers 202a may be managed by a third party, such as a third party image recognition service This may be accomplished, in whole or in part, using a machine learning model. For example, the third-party servers 202a may train, manage, provide input to, and/or receive output from machine learning models, such as those which might be implemented using a deep neural network. For example, the one or more third-party servers 202a may be configured to train a machine learning model based on training data to generate a trained machine learning model, may be configured to store all or portions of data (e.g., trained weights) associated with a trained machine learning model, may be configured to provide input to a trained machine learning model, and/or may be configured to receive output from a trained machine learning model. Examples of such servers may include the TinEye reverse image search engine by Idée, Inc. of Toronto, Ontario, Canada and the Image and Video Moderation API by Sightengine of Paris, France.

Though depicted as different elements, the one or more social media application servers 202b and the one or more third-party servers 202a may comprise a single server (e.g., a single one of the one or more servers 201) and/or multiple servers. For example, the one or more social media application servers 202b and the one or more third-party servers 202a may be distributed across a cloud computing environment, located on a single computing device, or the like.

The one or more user devices 203 may comprise devices such as smartphones, laptops, desktop computers, tablets, and the like. The one or more user devices 203 may be configured to store and/or execute one or more social media applications. For example, the one or more user devices 203 may store programs that, when executed, interface with the one or more social media application servers 202b and provide a dating and/or matchmaking service by allowing users to browse other users' profiles and, as desired, initiate connections with those users. Such an interface may be effectuated via a user interface which may be displayed on one or more display screens of the one or more user devices 203. Users might provide user input (e.g., via a touchscreen and/or via one or more input devices) to indicate interest in other users which, in certain circumstances, might initiate connections with those other users.

The one or more public photo databases 204 may be databases which store information about a variety of images. For example, the one or more public photo databases 204 may store hashes and/or copies of one or more images and may be queried to determine whether an input image is similar to an image stored by the one or more public photo databases 204. As will be described below, the one or more public photo databases 204 may be queried in this manner to ensure that users do not try to upload publicly-available photos to their user profile and instead upload unique images to their user profile. Examples of such databases may include the TinEye reverse image search engine by Idée, Inc. of Toronto, Ontario, Canada and the Google Images service provided by Google LLC of Mountain View, California.

To provide an example of how the devices depicted in FIG. 2 might work together, a user might, via the one or more user devices 203, upload an image to their user profile by sending, to the one or more social media application servers 202b, the image. The one or more social media application servers 202b may ensure that the image does not contain any human faces (e.g., using an object recognition algorithm and/or a facial recognition algorithm) and is not similar to one or more images already uploaded by the user (e.g., by comparing objects depicted in the images to objects depicted in other images uploaded by the user). The one or more social media application servers 202b may also query the one or more public photo databases 204 to ensure that the image was not, for example, downloaded off the Internet. Once such confirmations are performed, the one or more social media application servers 202b may store the image and/or may store one or more keywords associated with the image such that the keywords are associated with a user profile. Those keywords may then be used to match the user with a second user. As part of that process, the one or more social media application servers 202b may cause the one or more user devices 203 to display a second user profile and receive input associated with that second user profile. If the user positively responds to the second user profile (by, e.g., swiping right on a touchscreen of the one or more user devices 203) and/or if the second user responds positively to a first user profile of the user, the users might be matched, a communications session might be instantiated. In some circumstances, additional photos of the second user (e.g., a photo depicting their face) might be displayed on the one or more user devices. With that said, in certain circumstances, user profiles might not contain any form of facial photos, and users might instead have to share facial photos separately (e.g., as part of the communications session).

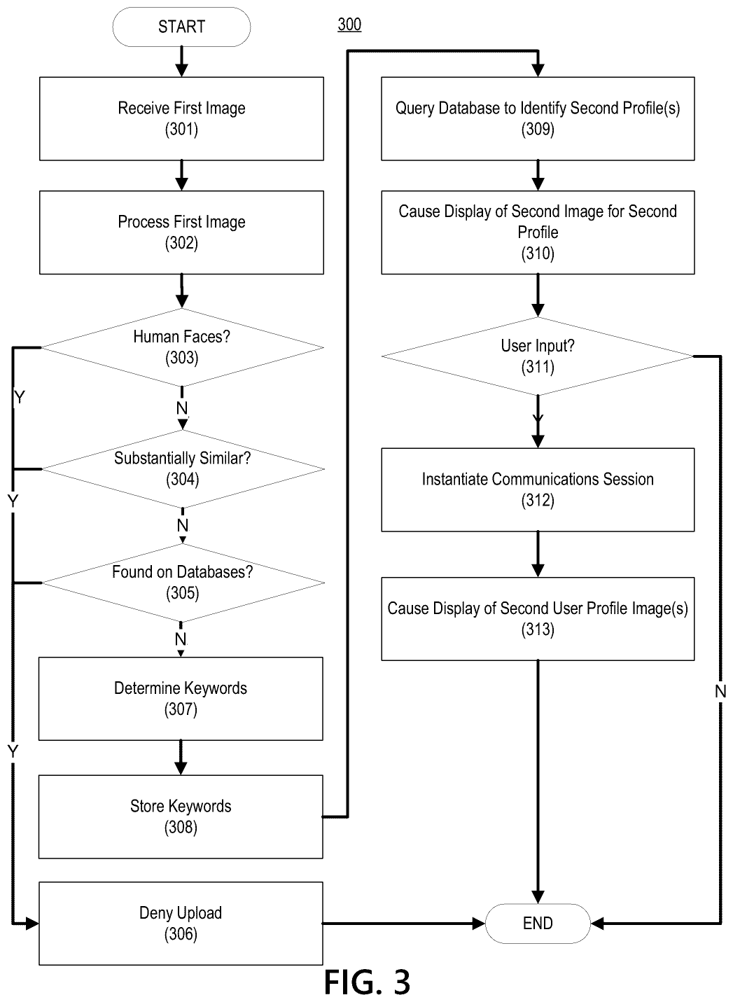

FIG. 3 depicts a flow chart depicting a method 300 comprising steps which may be performed to provide a social media application. A computing device may comprise one or more processors and memory storing instructions that, when executed by the one or more processors, cause performance of one or more of the steps of FIG. 3. One or more non-transitory computer-readable media may store instructions that, when executed by one or more processors of a computing device, cause the computing device to perform one or more of the steps of FIG. 3. Additionally and/or alternatively, one or more of the devices depicted in FIG. 2, such as the one or more servers 201 and/or the one or more user devices 203, may be configured to perform one or more of the steps of FIG. 3. For simplicity, the steps below will be described as being performed by a single computing device; however, this is merely for simplicity, and any of the below-referenced steps may be performed by a wide variety of computing devices, including multiple computing devices.

As an introduction, step 301 through step 308 describe a process whereby a user might upload an image and the image might be processed to ensure that it complies with a variety of restrictions that beneficially ensure an optimal social media application. For example, as will be detailed below, various algorithms may be used to ensure that an image lacks human faces, is not substantially similar to already-uploaded images, and cannot be found publicly (such that the image is sufficiently original to the user).

In step 301, the computing device may receive a first image. This process might involve a user uploading, via the one or more user devices 203, an image to the one or more social media application servers 202b. The image might be retrieved from storage of the one or more user devices 203 and/or may be captured via a camera of the one or more user devices 203. For example, the computing device may receive a first image to be associated with a first user profile corresponding to a first user. The image might be uploaded via one or more applications, such as a social media application, a web browser application, or the like. While many portions of the present disclosure reference images, all aspects described herein apply equally to videos and/or animated images, such as .GIF files.

As a brief introduction, step 302, step 303, step 304, step 305, and step 306 describe various image processing steps. These processing steps may be performed to ensure that photos reflect user interests and not user faces (and, e.g., do not contain words, do not contain salacious content, are not duplicative of already-uploaded photos, and the like). These steps might be performed by a single device or a plurality of devices. In particular, while the steps described below are described as being performed by a single computing device for the purposes of simplicity, various different third-party services (e.g., implemented via the third-party servers 202a) may be used to perform such processing. For instance, one third-party service might be used to do face recognition, another third-party service might be used to detect embedded words and/or explicit content, another third-party services may be used to perform reverse image searching, and the like.

In step 302, the computing device may process the first image. Processing the image may comprise identifying one or more objects in the image using one or more algorithms, such as one or more object recognition algorithm. For example, the computing device may process, using an object recognition algorithm, the first image to identify one or more objects in the first image. Such objects might include, for example, locations of the image (e.g., by processing a background of the image), a subject of the image (e.g., whether the image is of a human being, an animal, and/or object), and the like.

In step 303, the computing device may determine whether the first image comprises one or more human faces. As indicated above, it may be desirable to ensure that users do not upload images of their face (or the face of others), as doing so may encourage other users to match with them based on physical attractiveness. Determining whether the first image comprises one or more human faces may comprise determining whether the object(s) determined in step 302 comprise a human being or a human-like object. Additionally and/or alternatively to such use of object recognition algorithms, facial recognition algorithms and/or human detection algorithms may be used. In turn, if the first image does not comprise one or more human faces, the method 300 proceeds to step 304. Otherwise, the method 300 proceeds to step 306, where the computing device may deny upload of the first image.

As indicated above, determining whether the first image comprises one or more human faces may additionally and/or alternatively comprise use of a facial recognition algorithm. Where such a facial recognition algorithm detects a face, upload of an image may be prevented. For example, the computing device may receive a fourth image to be associated with the first user profile corresponding to the first user, process, using a facial image recognition algorithm, the fourth image, and, based on determining that the first image contains at least one human face, cause output, in the user interface, of a notification that the fourth image will not be added to the first user profile. Such a process might be performed in addition to and/or in replacement of the object recognition algorithms described above with respect to step 302. For example, the object recognition algorithm might simply identify that a human is in a photo (which might be permissible in certain circumstances, such as where a user's feet might be inadvertently visible in a photo taken by the user when kayaking), facial recognition algorithms may be executed responsive to the object recognition algorithm's detection of a human, and the facial recognition algorithm might determine that a human face is in the photo (which might not be permissible, such that upload of the image may be prevented).

In step 304, the computing device may determine whether the first image comprises objects substantially similar to one or more already-uploaded images. It may be desirable to ensure that users upload a wide variety of images, rather than images depicting substantially similar content. In turn, the computing device may be configured to prevent users from uploading photos that depict objects and/or scenarios too similar to images they have already uploaded. In turn, if the first image does not comprise objects substantially similar to one or more already-uploaded images, the method 300 proceeds to step 305. Otherwise, the method 300 proceeds to step 306, where the computing device may deny upload of the first image.

Determining whether the first image comprises objects substantially similar to one or more already-uploaded images may comprise comparing objects identified in already-uploaded images to objects in an image submitted by a user. For example, the computing device may receive a fourth image to be associated with the first user profile corresponding to the first user and process, using the object recognition algorithm, the fourth image to identify one or more second objects in the fourth image. Then, based on determining that a similarity between the one or more objects and the one or more second objects satisfies a threshold, the computing device may cause output, in the user interface, of a notification that the fourth image will not be added to the first user profile. Additionally and/or alternatively, based on determining that keywords associated with the first image are similar to keywords associated with one or more already-uploaded images, the computing device may cause output, in the user interface, of a notification that the fourth image will not be added to the first user profile. To provide an example of this process, if a user has already uploaded a photo of their dog, then the user might be prevented from uploading a second photo of their dog until the previous photo is removed (and/or on the condition that the second photo replaces the previous photo). This may operate to ensure that the user's profile comprises a wide variety of images, rather than a photo album of (for example) only their dog.

In step 305, the computing device may determine whether the first image can be found on external databases, such as the one or more public photo databases 204. To ensure that users upload photos that sufficiently reflect their real personality, the computing device may be configured to prevent the user from uploading stock images or other photos that might be accessible publicly. After all, such photos might not be sufficiently reflective of the user's personality or interests. In turn, if the first image cannot be found on external databases, the method 300 proceeds to step 307. Otherwise, the method 300 proceeds to step 306, where the computing device may deny upload of the first image.

To determine whether the first image can be found on external databases, reverse image search engines may be used. For example, the computing device may receive a fourth image to be associated with the first user profile corresponding to the first user, send the fourth image to a reverse image search engine, and, based on receiving, from the reverse image search engine, an indication that the fourth image has been uploaded on a website, cause output, in the user interface, of a notification that the fourth image will not be added to the first user profile.

In addition to the decisions referenced above, the computing device may also block the upload of images that contain words, phrases, or the like. It is common for some users to try to circumvent limitations on social media applications by, for example, uploading images that contain other social media handles. To avoid this (and similar) circumvention, the computing device may, based on determining that an image contains text (e.g., as determined via an object recognition algorithm), block upload of the image in a manner similar to step 303, step 304, and/or step 305.

In step 307, the computing device may determine one or more keywords associated with the first image. For example, the computing device may, based on determining that the first image does not contain any human faces, determine, based on the one or more objects in the first image, one or more first keywords. The one or more keywords may describe and/or may be otherwise associated with objects detected in the first image. For example, if a user uploads an image of their dog, keywords might comprise words such as “dog,” “animal,” “pets,” “dachshunds,” and the like. The one or more keywords may additionally and/or alternatively describe concepts associated with the image that are not necessarily descriptive of objects in the image. For example, for an image depicting a hiking trip, the one or more keywords may comprise words such as “adventure,” “athleticism,” and the like.

The keywords may be generated based on metadata of the image(s). For example, if an image's metadata indicates that it was taken in a particular location (e.g., Bali), then this may suggest keywords such as “Bali,” “Travel,” “Indonesia,” “Southeast Asia,” and the like. As another example, if an image's metadata depicts an image of a church on December 25, the keywords may include “Religious,” “Christmas,” and the like.

In step 308, the computing device may store the keywords. The keywords may be stored in a database, in association with a user profile, and/or along with the image. For example, the computing device may, based on determining that the first image does not contain any human faces, store, as part of the first user profile, the first image and the one or more first keywords. In this manner, user profiles may comprise not merely images (e.g., which may be displayed in a collage to users), but also keywords associated with those images (which, as will be described below, can be used to match different users based on their profiles).

Step 309 through step 313 describe a process whereby users might be matched based on keywords established via their user profiles. Users might be provided collages of uploaded images associated with other users' profiles, and then those users might be permitted to indicate interest with respect to other users. If two users indicate interest in one another (e.g., by right-swiping on a touchscreen in response to display of various images from the other user's profile), those users might be matched, a communications session might be instantiated between the two users. In some circumstances, the two users might still not be permitted to see facial pictures of one another (and, indeed, no such photos might be stored). With that said, in some circumstances, the users might be permitted to view a wider variety of images of the other user (e.g., might be permitted to see additional photos depicting other interests of the user).

In step 309, the computing device may query a database to identify one or more second user profiles. A user might be provided opportunities to match with other users based on a comparison of keywords from their profile and keywords associated with other user's profiles. For example, the computing device may query, based on the one or more first keywords, a database to identify one or more second keywords associated with a second user profile corresponding to a second user. In some cases, users might be provided the opportunity to match with other users based on keyword similarities identified based on such queries. For instance, if a first user establishes a user profile that indicates that they enjoy cars, the computing device may query for other user profiles that also indicate that their corresponding user enjoys cars and might display those other user profiles to provide the first user an opportunity to indicate interest or disinterest. With that said, different keywords may be associated without necessarily being identical, and users might be provided the opportunity to match with other users without keywords being identical. For instance, if one user establishes a user profile that indicates that they enjoy cars, the computing device may query for other user profiles that indicate that their corresponding user enjoys vehicles such as motorcycles, boats, and the like.

To better match users, keyword associations may be determined and stored by the computing device, and those keywords may be used to identify possible connections between different users. For example, users associated one keyword (e.g., cars) might not necessarily wish to date other users interested in the same keyword, but historical matching activity may indicate that they prefer significant others with another hobby (e.g., flowers). In turn, while the keywords “cars” and “flowers” might not, standing alone, have any association, the two might be associated in that the two users might find one another interesting. In turn, such associations may be stored by the computing device and used to query the database. For instance, if a first user has the keyword “cars” in their profile, then the querying process may query on both “cars” and “flowers.”

In step 310, the computing device may cause display of a second image associated with a second user profile. Such images might reflect one or more other interests of a user. For example, the computing device may display a collage of images associated with the second user profile. That collage of images may comprise a second image associated with the second user profile and one or more additional images.

In step 311, the computing device may determine whether user input is received. User input may comprise any indication that a user wishes to match with a second user associated with a second user profile. For example, the computing device may, based on the querying performed in step 309, identify a second user profile of potential interest to a user, display one or more images associated with that second user profile on the one or more user devices 203, and monitor whether user input (e.g., a right swiping action or clicking a “heart” button) is received that indicates interest in the second user profile. With respect to the second image described above with respect to step 310, the user input associated with the second image may comprise a swiping touch input associated with the collage of images (e.g., associated with the collage and/or associated with a single image of the collage).

In step 312, if the user input was detected, the computing device may instantiate a communications session. The communication session may comprise a text, video, and/or voice chat session. For example, the computing device may, based on receiving user input associated with the second image that indicates that the first user wishes to match with a second user, instantiate a communications session between the first user and second user. In this manner, in the case where a user indicates a desire to match with a second user, the two users might be prompted to communicate via an instantiated communications session. That said, in some circumstances, it may be required that both users indicate interest before a communications session is instantiated.

Instantiating a communication session may comprise generating a discussion prompt. The discussion prompt may be generated based on keywords associated with user profiles. For example, the computing device may generate, based on the one or more first keywords and the one or more second keywords, a discussion prompt for the first user and the second user and cause display, in the user interface, of the discussion prompt. Such generation may comprise use of one or more template discussion prompts (e.g., “What do you think of [TOPIC]?”) and/or using a natural language algorithm, such as a language learning model implemented using one or more machine learning models. In this manner, users might not be merely connected via the communications session, but the users might be connected in a manner that prompts them to discuss (for example) a shared interest.

In step 313, the computing device may cause display of one or more second user profile images. In some circumstances, in addition to establishing a communication session, users might be rewarded for connecting together by being allowed to see additional images from a user's profile. For example, the second image(s) displayed in step 310 might comprise five additional images, whereas eight additional images might be displayed as part of step 313. That may advantageously give users an even broader spectrum of topics (e.g., mutual/different interests to discuss. In some circumstances, the users might be, upon connection, allowed to see photos depicting the other user (e.g., their face and/or their body). For example, the computing device may, based on receiving user input associated with the second image, cause display of a third image associated with the second user profile. In this manner, in some embodiments, the users, once connected, might be able to see what each other look like. With that said, in many circumstances, the method described herein intentionally does not store images of other users' appearances. In those circumstances, users would need to share images of one another depicting their appearances separately (e.g., via the communications session), as the system would not have the ability to send such images of those users. This is often a preferred approach, as it ensures that users' appearances are not disclosed until they are fully comfortable with their appearances being disclosed.

Discussion will now turn to one implementation of the social media application system that is focused on identifying (and preventing upload of) images containing human faces. This approach is in many ways identical to the process described above, though it contains (for example) many illustrative software components and details about how user profiles might be structured.

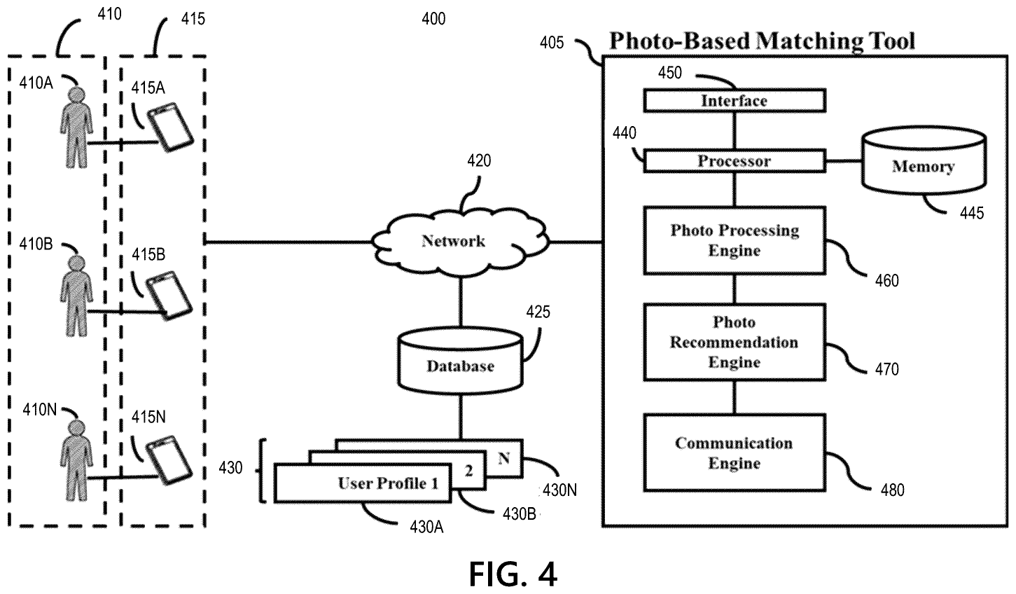

FIG. 4 illustrates a system 400 for providing a social media application. The system 400 includes photo-based matching tool 405 (which may be the same or similar as the one or more social media application servers 202b), user(s) 410, device(s) 415 (which may be the same or similar as the one or more user devices 203), network 420 (which may be the same or similar as the network 103), and database 425. Generally, the photo-based matching tool 405 determines that users 410 take actions in system 400. The photo-based matching tool 405 includes a photo processing engine 460, a photo recommendation engine 470, and a communication engine 480. The photo processing engine 460 ensures that photos uploaded to the system conform to the rules of the system. The photo recommendation engine 470 displays interest-based profile photos 437 to users 410. Based on interest-based profile photos, users may determine whether they would like to interact via communication engine 480.

The devices 415 include any appropriate device for communicating with components of system 400 over network 420. For example, the device 415 may be or may be accompanied by a telephone, a mobile phone, a computer, a laptop, a tablet, a server, an automated assistant, and/or a virtual reality or augmented reality headset or sensor, or another device. This disclosure contemplates device 415 being any appropriate device for sending and receiving communications over network 420. As an example, and not by way of limitation, device 415 may be a computer, a laptop, a wireless or cellular telephone, an electronic notebook, a personal digital assistant, a tablet, or any other device capable of receiving, processing, storing, and/or communicating information with other components of system 400. The device 415 may also include a user interface 450, such as a display, a microphone, keypad, or other appropriate terminal equipment usable by user 410. An application executed by device 415 may perform the functions described herein. The devices 415 may communicate with photo-based matching tool 405 through network 420 via a web interface. An application executed by device 415 may perform the functions described herein.

The network 420 facilitates communication between and amongst the various components of system 400. The network 420 may comprise any suitable network operable to facilitate communication between the components of system 400. The network 420 may include any interconnecting system capable of transmitting audio, video, signals, data, messages, or any combination of the preceding. The network 420 may include all or a portion of a public switched telephone network (PSTN), a public or private data network, a local area network (LAN), a metropolitan area network (MAN), a wide area network (WAN), a local, regional, or global communication or computer network, such as the Internet, a wireline or wireless network, an enterprise intranet, or any other suitable communication link, including combinations thereof, operable to facilitate communication among the components.

The database 425 stores a set of user profiles 430. The user profiles 430 define or represent features of users 410 as will be described in more detail below. The user profiles 430 may be available to the general public, to those that are members of system 400, and/or to a specific category of those members of system 400. The user profiles 430 may contain information that was solicited from users 410 as will be described in more detail below. User profiles 430 may include general information such as age, height, gender, and occupation, as well as detailed information that may include the users' interests, likes/dislikes, personal feelings, and/or outlooks on the world. The photo recommendation engine 470 may review user profiles 430 to determine which interest-based profile photos to recommend. The photo-based matching tool 405 may operate on, change, remove, or add information to user profiles 430 that have been stored in database 425. This may be based on an interaction among users 410. This may be based on an interaction between users 410 and interest-based profile photos 437 of users 410. The photo recommendation engine 470 may review photo properties of interest-based profile photos 437 to make recommendations.

As seen in FIG. 4, photo-based matching tool 405 includes processor 440, memory 445, and interface 450. This disclosure contemplates processor 440, memory 445, and interface 450 being configured to perform any of the functions of photo-based matching tool 405 described herein.

Processor 440 may be the same or similar as the processor 111 and may be any electronic circuitry, including, but not limited to microprocessors, application specific integrated circuits (ASIC), application specific instruction set processor (ASIP), or state machines, that communicatively couples to memory 445 and interface 450 and controls the operation of photo-based matching tool 405. The processor 440 may be 7-bit, 46-bit, 62-bit, 54-bit, or any other suitable architecture. The processor 440 may include an arithmetic logic unit (ALU) for performing arithmetic and logic operations, processor registers that supply operands to the ALU and store the results of ALU operations, and a control unit that fetches instructions from memory and executes them by directing the coordinated operations of the ALU, registers and other components. The processor 440 may include other hardware and software that operates to control and process information. The processor 440 executes software stored on memory 445 to perform any of the functions described herein. The processor 440 controls the operation and administration of photo-based matching tool 405 by processing information received from network 420, device(s) 415, interface 450, database 425, and memory 445. The processor 440 may be a programmable logic device, a microcontroller, a microprocessor, any suitable processing device, or any suitable combination of the preceding. Processor 440 is not limited to a single processing device and may encompass multiple processing devices.

Memory 445 may be the same as the RAM 113 and/or the ROM 115 of FIG. 1 and may store, either permanently or temporarily, data, operational software, or other information for processor 440. The memory 445 may include any one or a combination of volatile and non-volatile local or remote devices suitable for storing information. For example, the memory 445 may include random access memory (RAM), read only memory (ROM), magnetic storage devices, optical storage devices, or any other suitable information storage device or a combination of these devices. The software represents any suitable set of instructions, logic, or code embodied in a computer-readable storage medium. For example, the software may be embodied in memory 445, a disk, a CD, or a flash drive. The software may include an application executable by processor 440 to perform one or more of the functions described herein. The memory 445 may store multiple databases, such as database 425.

Interface 450 represents any suitable device operable to receive information from network 420, transmit information through network 420, perform suitable processing of the information, communicate to other devices, or any combination of the preceding. For example, interface 450 transmits notifications to devices 415. As another example, interface 450 may facilitate the exchange of messages during an interaction among users 410, for example, by receiving a message transmitted by user 410A for ultimate receipt by user 410B and then transmitting the message to user 410B. As yet another example, interface 450 may display interest-based profile photos 437 to users 410. The interface 450 represents any port or connection, real or virtual, including any suitable hardware and/or software, including protocol conversion and data processing capabilities, to communicate through a LAN, WAN, or other communication systems that allows photo-based matching tool 405 to exchange information with devices 415 and/or other components of system 400 via network 420. The interface 450 may further comprise any suitable interface for a human user such as a video camera, a microphone, a keyboard, a mouse, or any other appropriate equipment according to particular configurations and arrangements.

The photo-based matching tool 405 may implement photo processing engine 460, photo recommendation engine 470 and communication engine 480. The photo processing engine 460 ensures that photos uploaded to the system conform to the rules of the system. The photo recommendation engine 470 is used to display interest-based profile photos 437 of users 410, as described in further detail below. The communication engine 480 is used to create and provide a type of interaction for users 410.

### Users and User Profiles

As depicted in FIG. 4, system 400 includes a plurality of users 410. Users 410 may comprise clients, customers, prospective customers, businesses, or any other entities wishing to participate in an on-line matching or networking scenario (e.g. dating) and/or to view information associated with other users 410 in system 400. The users 410 interact with photo-based matching tool through devices 415. The users 410 may seek to receive recommendations of other users 410. The users 410 may also seek to access or review other users 410. The users 410 may also seek to be accessed by or reviewed by other users 410. The users 410 may also seek to communicate with other users 410 in system 400.

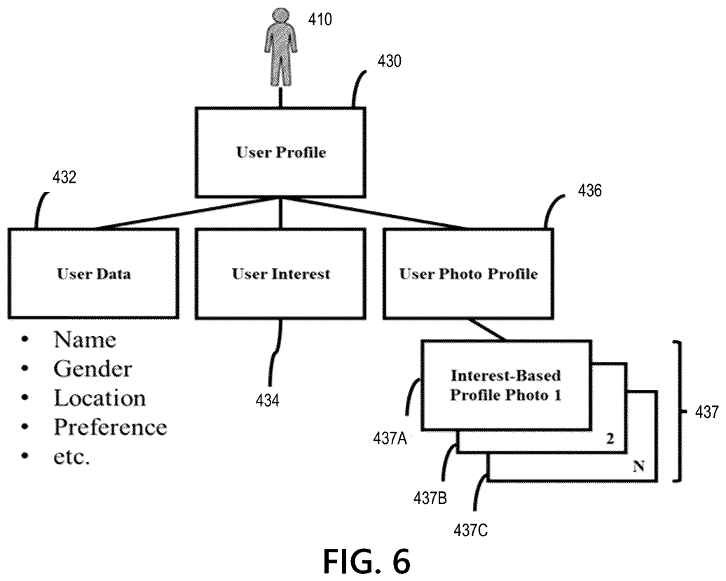

User 410 may be associated with a user profile 430. Establishing the user profile 430 may occur during registration. As seen in FIG. 6, user profile 430 may include as components user data 432, user interests 434 (which may be the same or similar as the keywords referenced above with respect to FIG. 3), user photo profile 436, and user interaction history. When user 410 accesses other user 410, user 410 may access user profile 430. The user 410 may access all components within user profile 430 of other users 410. Additionally and/or alternatively, the user 410 may access only certain components (e.g. user photo profile 436) but not all components within user profile 430 of other users 410. When user 410 is accessed by other user 410, user profile 430 may be accessed. All components within user profile 430 of a user 410 may be accessed by other users 410. Additionally and/or alternatively, only certain components (e.g. user photo profile 436) but not all components within user profile 430 of a user 410 may be accessed by other users 410.

User profile 430 may include user data 432. The user data 432 includes relevant information of users 410. The user data 432 may include name, gender, height, weight, age, location, ethnicity, birthplace, eating habits, activities, goals, interests, likes/dislikes, personal feelings, and/or outlooks on the world of users 410. The user data 432 may include name, gender, age, and location of users 410. Such user data 432 may further include information regarding what users 432 may be looking for in recommendations or matches, such as gender, age, age range, weight, height, location, ethnicity, diet, education, and distance from a corresponding user. Such information may include genders, age range, and distance from user. Additional such user data 432 may include statistics associated with a user's usage of the system 400 (e.g., amount of time using the system 400, engagement level in the communication engine 480, and “freshness” e.g., how frequently the user 410 uploads new photos).

The system 400 may include a network 420 that interfaces with one or more users 410 to establish user data 432 within user profile 430 for each of the users 410. Establishing user data 432 may occur during registration. Registration may include users 410 submitting information to network 420 about users 410 as well as information regarding what users 410 may be looking for in recommendations or matches. The network 420 may be configured to collect this information. For example, the network 420 may specify that any number of questions or requested descriptions are necessary before registration may be concluded. As an example, the network 420 may require that user 410 communicate the gender of user 410 and the gender user 410 prefers to be matched with. After concluding the registration process, network 420 may store the responses of user 410 as user data 432 within user profile 430 in database 425. This same process may be repeated by several different users 410 causing database 425 to contain a plurality of user profiles 430 which may be accessed by network 420. Updating user data 432 may also occur at any time after registration. Updating user data 432 within user profile 430 may include users 410 submitting information to network 420 about users 410 as well as characteristics with which users 410 are seeking to be matched. The network 420 may be configured to collect this information.

Establishing a location of user 410 may utilize a location module. The location module may be a component of devices 415. The location module may be implemented using any suitable combination of hardware, firmware, and software. The location module may determine information regarding the physical location of device 415. Examples of such location information include latitude/longitude coordinates, physical address, zip code, area code, city, county, state, country, and geographic area. The location module may determine the location information using one or more suitable technologies, such as Global Positioning System (GPS), available IEEE 702.11 networks, and cellular radio signals. For example, the location module may use triangulation of wireless signals such as 702.11 networks and/or cellular radio signals. As another example, Uplink Time Difference of Arrival (U-TDOA) may be used by the location module to determine location information. The location module may determine location information using input from a user (such as users 410). For example, the location module may use user input as one factor in determining location and rely on other technologies to determine the location of device 415. As another example, the location module may allow user 410 to specify location information (e.g., an intersection, an address, or a business). A user may specify location information by selecting location information from a list or map provided by the location module. The location may update at the request of user 410 and/or may automatically update based on a determination that the user 410 has moved.

The user data 432 of user 410 might not be accessible by other users 410 and is only used by the photo recommendation engine 470. Additionally and/or alternatively, user data 432 of a user 410 may be accessible by other users 410. Certain information (e.g. name) but not all information within user data 432 of a user 410 may be accessed by other users 410. In some circumstances, the user data 432 of user 410 may be used to target relevant advertisements to user 410.

User profile 430 may include user interests 434. User interests 434 includes additional relevant characteristics of corresponding users 410. The user interests 434 include additional information regarding what users 410 may be looking for in recommendations or matches (e.g., interests). Such user interests 434 include keywords of interest (e.g., cats, hiking, travel, etc.). The user interests 434 may also include additional information regarding what users 410 may not be looking for in recommendation or matches (e.g., disinterests). Such user interests 434 include keywords of disinterest (e.g., cooking, exercise, countryside, etc.). Such interests and disinterests may also be weighted. For example, if over a period of time, a user 410A uploads 10 photos of dogs and 2 photos of cats, “dogs” as an interest will be given more weight than “cats” as an interest.

The system 400 may include a network 420 that interfaces with one or more users 410 to establish user interests 434 within user profile 430 for each of the users 410. Establishing user interest 434 may occur during registration. Registration may include users 410 submitting keywords of interest to network 420. The network 420 may be configured to collect this information. Additionally and/or alternatively, establishing user interests 434 does not occur during registration. For instance, establishing user interest 434 might occur only after registration. Updating user interests 434 may occur at any time after registration. Updating user interests 434 may include users 410 submitting keywords of interest to network 420. Updating user interests 434 may include users 410 removing keywords of interest. The network 420 may be configured to collect this information.

Establishing user interests 434 may be automatic and, e.g., based on images uploaded by the user. Moreover, updating user interests may be automatic. Additionally and/or alternatively, establishing or updating user interests may be a combination of manual submission or deletion by users 410 and automatic establishing or automatic updating. As will be described in further detail below, user interests 434 of user 410 may be automatically established or updated based on positive or negative interactions of user 410 with other users 410 or with interest-based profile photos 437 of other users 410. In some embodiments, user interests 434 may be established by connecting to other social-networking systems (e.g. Facebook, Instagram, or Google) which already store information related to the user's interests or disinterests. In some embodiments, user interests 434 may be established by the photo processing engine being applied to photo galleries owned by the user (e.g. on their device and/or other social-networking systems) to identify keywords. Additionally, it should be noted that a user's user interest 434 may evolve over time. As more data is available, for example, after additional photo uploads by a user and/or based on their interactions within the system, such user's user interest 434 will be updated.

As will be described in further detail below, photo recommendation engine 470 may use keywords of interest within user interest 434 of user 410A to recommend to user 410A interest-based profile photos 437 of another user 410B whose user photo profile includes interest-based profile photos having same keywords. Additionally and/or alternatively, photo recommendation engine 470 may use keywords of interest within user interests of user 410A to recommend to user 410A interest-based profile photos of other users 410 having same keywords.

The user interest 434 of user 410 might not be accessible by other users 410 and might only used by the photo recommendation engine 470. The user interest 434 of a user 410 may be accessible by other users 410. Additionally and/or alternatively, certain information but not all information within user interest 434 of a user 410 may be accessed by other users 410. Additionally and/or alternatively, user interest 434 of user 410 may be used to target relevant advertisements to user 410.

User profile 430 may include user photo profile 436. The user photo profile 436 may include interest-based profile photos 437. When user 410A accesses user photo profiles 436 of other users 410, user 410A may access the entire user photo profile 436 or individual interest-based profile photos 437 within user photo profile 430. For instance, the user photo profile 436 comprises more than one interest-based profile photo 437.

The system 400 may include a network 420 that interfaces with one or more users 410 to establish user photo profile 436 within user profile 430 for each of the users 410. Establishing user photo profile 436 may occur during registration. Registration may include users 410 submitting interest-based profile photos 437 to network 420. Establishing user photo profile 436 might not occur during registration. Establishing user photo profiles 436 might occur only after registration. Updating user photo profile 436 might occur at any time after registration. Updating user photo profiles 436 may include users 410 submitting interest-based profile photos 437 to network 420 via photo processing engine 460. Updating user photo profiles 436 may include users 410 removing interest-based profile photos 437. The network 420 may be configured to collect interest-based profile photos 437 to establish or update user photo profile 436. For instance, updating user photo profile 436 may be automatic. The user photo profile 436 of user 410 may be the only component of user profile 430 of user 410 that is accessible by other users 410.

It should be noted that in a preferred embodiment, the photo profile 436A and corresponding interest-based profile photos 437, collectively absent of words, may be the only components of a user profile 430A of user 410A that may be viewed by other users. This may be particularly advantageous for several reasons. One such advantage is that user 410A does not need to spend time arduously filling out surveys or deciding what to write about themselves as is typical of traditional social media and dating applications. Conversely, other users that view the photo profile 436A of user 410A do not need to be distracted and/or overwhelmed by a wall of text. This process might also ensure that user profiles are reasonably accurate and timely. For instance, because uploaded photos might expire over time (and/or because such photos are required to be original and not simply downloaded off the Internet), user profiles might more accurately depict the real interests and activity of a particular user. As a particular example, a user might not be able to feign an interest in hiking without uploading an original photo from a recent hike.

### Photos

The system 400 includes a plurality of photos or videos (collectively referred to herein as photos; also referred to as images, used interchangeably herein). In this regard, this disclosure contemplates at least the following categories of photos: interest-based profile photos 437 and messaged photos. Interest-based profile photos 437 form the basis of a user photo profile 436 of a user 410. Messaged photos are sent by one user 410 to another user 410 while communicating via communication engine 480. Users 410 may interface with network 420 to upload photos. Network 420 may be configured to collect and store photos from users 410. Photos may be filtered and/or processed by photo processing engine 460. Photos may include photo properties including, but not limited to, keywords.

System 400 may be configured so that users 410 create user photo profiles 436 that include interest-based profile photos 437 that are substantially absent of human faces, and optionally, that are further absent of other impermissible features and contents such as physical features and/or words. User photo profiles 436 might not include interest-based profile photos 437 that are not substantially absent of human faces. To ensure that interest-based profile photos 437 are substantially absent of human faces, photos uploaded by users are filtered by photo processing engine 460 as will be described in further detail below. The photo processing engine 460 will only permit successful upload of new interest-based profile photo 437 to user photo profile 436 if the new photo is substantially absent of human faces, and optionally further absent of other physical features and/or words. Upon successful upload of new photo as an interest-based profile photo 437 to user photo profile 436, the photo may be populated with photo properties as will be described in further detail below.

The interest-based profile photos 437 may include photo properties. The photo properties may be determined by photo processing engine 460. The photo properties may be input by user 410. The photo properties may be updated by system 400 or components of system 400 such as photo-based matching tool 405, photo recommendation engine 470 or communication engine 480. The interest-based profile photos 437 may include keywords. The keywords may be determined by photo processing engine 460. The keywords may be input by user 410. The keywords may be updated by system 400 or components of system 400 such as photo-based matching tool 405, photo recommendation engine 470 or communication engine 480.

The users 410 in the system 400 may interface with network 420 to upload photos. The user 410 uploaded photo may be an interest-based profile photo 437 that forms the basis of user photo profile 436 corresponding to user 410. The photo recommendation engine 470 displays interest-based profile photo 437 of user 410 to one or more of other users 410. The user 410 may view interest-based profile photos 437 of one or more of other users 410.

Through the processes described herein, the question of “how similar is one end user to another end user” may be answered, based how a user 410 interacts with interest-based profile photos 437 of other users 410. Furthermore, in many cases, the relevance of matches in a match-making system is more subjective than topical relevance. Positive or negative preferences for interest-based profile photos 437 having keywords can be a useful heuristic which reflects the actual desires/interests of a user. Recommendations and matches may then be identified and/or ranked based at least in part upon implicit indicators of relevance. Implicit indicators of relevance may include positive or negative preferences for interest-based profile photos 437 having certain tags.

In some cases, a user may realize they are interested in something they had not previously realized they had an interest for. For example, user 410A may have never had an interest in surfing. That said, upon viewing an interest-based profile photo 437 by another user 410B depicting a surf board, user 410A may be intrigued enough to communicate with user 410B despite not having previously had an interest in surfing.

A user may avoid embarrassment if their expression of preference for a profile was not reciprocated because they know they were not rejected as a result of superficial characteristics such as attractiveness. This may lead to users to more actively express their preferences. Such increased activity can be used by the matching system to generate more potential matches or better rankings of potential matches. Along those lines, the system 400 may be configured to allow direct communication by a user through communication engine 480 when there has been an expression of preference by another user. This may be advantageous because users can avoid browsing, deleting, or responding to unwanted messages.

Notably, a user 410A may have more than one interest-based profile photo 437, but less than a pre-determined maximum number. For example, the maximum number may be 2, 3, 4, 5, 6, 7, 8, 9, 10, 11, 12, 13, 14, 15, 16, 17, 18, 19, 20, 21, 22, 23, 24, 25, 26, or 27. In a preferred embodiment, the maximum number is 9. It is advantageous for a user 410A to have more than one interest-based profile photo 437, as user 410A will be able to showcase various facets of their personality and have multiple shots on goal to interest other users 410. For example, while another user 410B browses for potential matches, they may come across a first interest-based profile photo 437A of user 410A and express no interest and/or determine to not match; however, such other user 410B may later come across another interest-based profile photo of user 410A and express interest. It is advantageous for a user 410A to have no more than a maximum number of interest-based profile photos. One such advantage is so that other users 410 do not come across an unlimited number of interest-based profile photos from user 410A. Another such advantage is that with a limited number of interest-based profile photos, it is easier to make a quick but informed judgment of a user without being overwhelmed by too many such photos. Yet another such advantage is that with a limited number of interest-based profile photos, it is more fun for user 410A to take time to creatively determine the best way to represent themselves. Yet another advantage is that a limited number of interest-based profile photos forces user 410A to upload the highest quality representative photos to represent themselves.

While thus far, it has been contemplated that a user's photo profile is manually populated with photos from the user's device gallery and/or camera, it is also contemplated that the user's photo profile is automatically or semi-automatically populated. As described herein, it may be possible to connect to photo galleries owned by the user (e.g. on their device and/or other social-networking systems). The system 400 may automatically recommend photos from these photo galleries with which to populate the user's photo profile. To automatically recommend photos, machine learning techniques may be used. For example, an artificial neural network may implement a machine learning model that was trained using training data comprising a plurality of images tagged based on popularity, relevance, and/or similar factors. That machine learning model may be thereby trained to identify, for an input image, a predicted popularity, relevance, and/or the like. In turn, one or more images from a photo gallery may be input into the machine learning model and, based on the output, one or more of those images may be recommended for addition to the user's photo profile.

The present invention also contemplates messaged photos. Messaged photos are photos sent by user 410 to other users via communication engine 480 that are not interest-based profile photos. Unlike interest-based profile photos, messaged photos are less restricted and may, for example, include faces. Nonetheless, messaged photos may still be filtered by photo processing engine 460 to analyze said photos for any other impermissible features. Additionally, messaged photos may be processed to establish photo properties (e.g. keywords) and subsequently be used to update a users' user preference.

Photos may include photo properties. Photo properties includes relevant information of corresponding photos. Photo properties may include upload date, expiration date or time to expiration, freshness, statistics (e.g. popularity, number of times viewed, number of clicks), and keywords.

The system 400 may include a network 420 that is configured to establish photo properties of photos. Establishing photo properties may be achieved by network 420 interfacing with one or more users 410 to input photo properties. The system 400 may include photo processing engine 460 which is configured to establish relevant photo properties to uploaded photos.

Certain photo properties may enable a variety of advantages. For example, popularity may motivate users 410 to continue participating in the system or to continue posting similar photos. Additionally, popularity may assist various algorithms used within the system e.g. by the photo recommendation engine 470. Expiration date may enable mechanisms to ensure freshness of content in the system which may also motivate users 410 to continue participating in the system. Additionally, expiration date may solve for ghost accounts as will be further described below.

Photos may include keywords (e.g., keywords, as referenced with respect to FIG. 3). Keywords may include relevant descriptive characteristics of corresponding photos. For example, a photo of a surfboard may include keywords such as “outdoor”, “surfer”, “athlete”, “beach”, etc. The system 400 includes photo processing engine 460 which is configured to add relevant keywords to uploaded photos. This may be performed automatically by the photo processing engine 460. For example, the photo processing engine 460 may perform all or some of the steps described above with respect to step 307 of FIG. 3. Additionally and/or alternatively, this is performed by requesting that users 410 submit relevant keywords. The users 410 submitting relevant keywords may be the owner of the photo; and/or the users 410 submitting relevant keywords may be other users. Keywords may include location of the photo. This may be determined using the metadata on the photo.

The step of analyzing the at least one photo to provide keywords may comprise inputting the photo to a content detection application programming interface, API. The step of analyzing the at least one photo may then further comprise labelling the image file with at least one identifying keywords based on the content detected by the content detection API.

Classifiers may also be used in order to provide the user with suggested key words and information with which to tag each image. For example, a classification API may be used to suggest content information based the geographical location of the image, or conversely, suggest geographical location based on the content. Once the image has been tagged with information, the classification API will search for classifiers associated with this information. Such classifiers may be programmed into the classification API manually, or developed by the classification API by searching and analyzing images previously uploaded to the database 425. Therefore, based on an initial piece of information, the classification API will predict what other information may be relevant to the new image and present them to the user as options. For example, having determined that the image was taken in “Malibu Beach”, the classification API may suggest tags such as “surfing” or “walks on the beach” based on the classifiers associated with “Malibu Beach.”

People having similar and/or compatible interests and values should be matched together; however, effectively linking two participants together can prove to be a challenging endeavor. Typically, the question of “how similar is one user to another user” may be answered, based on a special questionnaire comprising of questions provided on the online social platform. The responses to the questions can be a useful heuristic which reflects the actual desires/interests of a user if the questions are designed appropriately. Traditionally, matching occurs based on search criteria and/or user profile information provided through a text-based questionnaire; however, it has been discovered that these questionnaires are sometimes inadequate because the answers/response provided to these text-based questionnaires may or might not truly reflect the actual desires and interests of a user. One inherent problem with text-based questionnaires is that users cannot easily represent or express subtle preferences (desires/interests) which cannot be or readily be verbalized by an end user (or that a text-based questionnaire cannot accurately capture those subtle preferences). Further, a user might not realize certain interests and values are of interest to them.

Keywords may provide an advantage in that user 410 may be provided with other users who have uploaded interest-based profile photos having similar keywords as user 410 which may interest user 410 in being matched with such users. Another example of how this may be advantageous is that photo-based matching tool 405 may provide photo recommendations or potential matches to user 410 in a manner that may be more relevant to user 410 given that such recommendations or matches have uploaded interest-based profile photos 437 having the same keywords as photos uploaded by user 410. This may provide an advantage in that user 410 may be provided with recommendations or potential matches to user 410 in a manner that may be more relevant to user 410 given that such recommendations or matches have uploaded interest-based profile photos 437 having keywords that correspond to user interests 434 of user 410. Keywords may additionally and/or alternatively be used by an artificial intelligence algorithm to recommend conversation starters and/or to target relevant advertisements to user 410.

### Photo Processing Engine

This disclosure contemplates a photo processing engine 460 to achieve one or more of the features described herein. As described above, photos which are either intended as interest-based profile photos 437 or messaged photos are uploaded by users.

Interface 450 may be operable to receive from a user 410 one or more photos or videos (collectively referred to herein as photos) to upload. The uploading process starts when the user chooses an image stored in the memory of the device 415 or a new image captured using a camera integrated to the device. In some embodiments, the user may only upload a new image captured using a camera integrated to the device. Additionally and/or alternatively, the user may import photos from other social-networking systems. The uploaded images may be in any image file format, for example, JPEG File Interchange Format, GIF Graphics Interchange Format, TIFF Tag Image File Format, or any other standardized means for storing digital images. Once a photo has been selected or captured, the photo is filtered and processed by the photo processing engine 460, for example, to determine whether the new photo is permissible.

Photo processing engine 460 may be a software module stored in memory 445 and executed by processor 440. Processing the photo at this step may include different actions depending on the context in which the photo was uploaded.

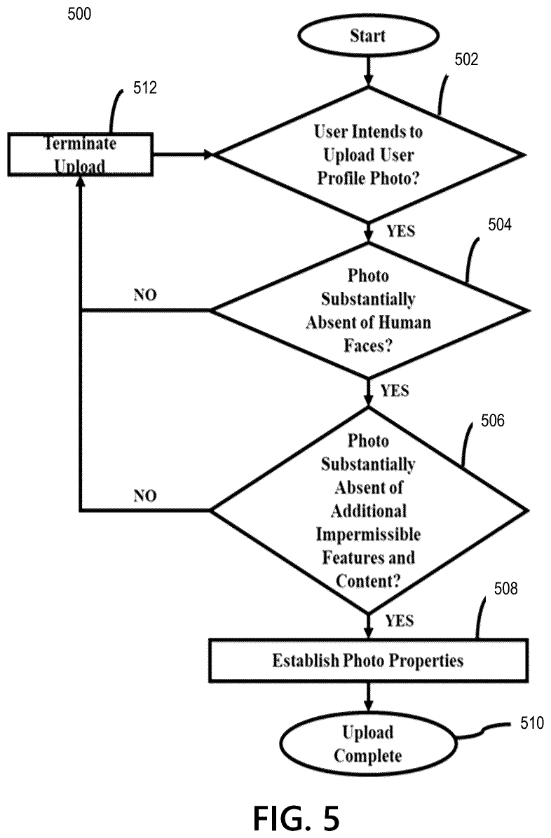

For example, if the photo was uploaded to be an interest-based profile photo 437, photo processing engine 460 may filter and process the photos as depicted as method 500 in FIG. 5 and described in further detail as follows. At step 502, the photo processing engine 460 may determine whether user 410 intends to upload a photo as an interest-based profile photo 437. The photo processing engine 460 may receive such photos from users 410 via network 420 from user device 415. For example, photo processing engine may receive information that user 410 intends to upload an interest-based profile photo. If, at step 502, photo processing engine 460 determines user 410 intends to upload a photo as an interest-based profile photo, the method 500 continues to step 504.

At step 504, the photo processing engine 460 may determine whether the photo is substantially absent of human faces. Photo processing engine 460 may determine whether the photo is substantially absent of human faces using a face detection API. If, at step 504, photo processing engine 460 determines that the photo is substantially absent of human faces, method 500 continues to step 506. In some circumstances, the method 500 does not include step 506 and instead continues to step 508. Additionally and/or alternatively, method 500 might not include step 508 and instead continues to step 510. If at step 504, photo processing engine 460 determines that a photo is not substantially absent of human faces, the method continues to step 512.

At step 506, photo processing engine 460 may determine whether the photo is substantially absent of additional impermissible features or content. Photo processing engine 460 may determine whether the photo is substantially absent of additional impermissible features or content using an API. If, at step 506, photo processing engine 460 determines that the photo is substantially absent of impermissible features or content, method 500 continues to step 508. The method 500 might not include step 508 and instead continues to step 510. If, at step 506, photo processing engine 460 determines that a photo is not substantially absent of additional impermissible features or content, the method continues to step 512.

At step 508, the photo processing engine 460 may establish photo properties. Photo processing engine 460 may establish photo properties using an API. After establishing photo properties, method 500 continues to step 510.

At step 510, photo processing engine 460 may complete the upload of the photo as an interest-based profile photo 437 in user photo profile 436 of user 410. The method 500 then returns to step 502.

At step 512, photo processing engine 460 may terminate photo upload and returns to step 502. At step 512, the photo may be sent for further analysis. This further analysis may be automatic. The image may be sent to a human analyst or to another computer or set of computers for further analysis. If approved in further analysis, method may continue, for example, to step 510.

It should be noted that all or portions of the steps depicted with respect to FIG. 5 may be the same or similar as steps depicted with respect to FIG. 3. For instance, step 502 of FIG. 5 may be the same or similar as step 301 of FIG. 3 (e.g., such that the decision in step 502 might be after step 301), step 504 of FIG. 5 may be the same or similar as step 303 of FIG. 3, step 506 may be the same or similar as step 304 and/or step 305 of FIG. 3, and the like.

As another example, if the photo was uploaded to be a messaged photo, the photo processing engine 460 may filter and process the photos as described in further detail as follows. An example algorithm for photo processing engine 460 is as follows: (1) receive a request to upload a photo as a messaged photo; (2) analyze photo to determine if photo is substantially absent of forbidden features (e.g. lewd content, etc.); (3) if the photo is not substantially absent of impermissible features, terminating the photo upload; and (4) if the photo is substantially absent of impermissible features, completing upload of photo and transmitting the messaged photo to intended user 410. This algorithm may optionally include additional steps. Such additional steps may include establishing photo properties, which may include establishing keywords.

If seeking to analyze photo to determine if photo is substantially absent of human faces, the application may launch a face detection algorithm which passes the photo through a face detection application programming interface (API) or any other suitable face detection software to determine whether any faces are present in the image. The face detection algorithm may detect faces from various angles, multiple faces in a photo simultaneously, with or without facial additions such as sunglasses or spectacles, as well as detect a range of expression and emotive characteristics, for example, the system can detect whether a person is smiling, have their eyes open or lips sealed. The software may source the location of eyes, nose, mouth and many other facial points for each face detected, and determine the gender and age of the individuals.

If the face detection algorithm does not detect a face, the face detection algorithm will return a certainty value of 0, and if the face detection algorithm does detect a face, it might return a certainty value of 4. The face detection software may detect faces from various angles, multiple faces in a photo simultaneously, with or without facial additions such as sunglasses or spectacles, as well as detect a range of expression and emotive characteristics, for example, the system can detect whether a person is smiling, have their eyes open or lips sealed. The software may source the location of eyes, nose, mouth and many other facial points for each face detected, and determine the gender and age of the individuals. The system may also distinguish the faces of humans from the faces of animals such that images containing the faces of animals may produce a result of 0. The face detection algorithm may return a value of 4 if any faces have been detected, even if the face detected has a low certainty, for example if the image is blurred. However, the face detection algorithm might not return a value of 4 if the face detected has a certainty below a threshold value such that the detected face has a very low certainty of it actually being a face or at least a visibly recognizable face, for example, a certainty below 40%.

In the context of the face detection algorithm substantially absent means that the space occupied by human faces and/or other forbidden features or contents constitutes less than a certain percentage of the total size of the photo. For example, substantially absent may mean the space occupied by human faces and/or other forbidden features or contents constitute less than 40%, 30%, 60%, 50%, 40%, 9%, 7%, 6%, 5%, 4%, 3%, 6%, 5%, 4%, 0.5%, or 0.25% the total size of the photo. Space occupied by human faces and/or other forbidden features or contents may be determined by various means as known in the art, including for example, number of pixels. Total size of the photo may be determined by various means as known in the art, including for example, number of pixels.

The photo processing engine 460 may be configured to analyze images received from users 410 and determine whether the photos include any other impermissible features. Impermissible features may comprise, for example, other representation of a user's physical attributes or words. The photo processing engine 460 may be configured to analyze images received from users 410 and determine whether the photos constitute impermissible content. Impermissible content may be content that may be readily found in the public domain (e.g. on Google Images or stock photos). The impermissible content may be content previously uploaded to the system 400. Such analyses may be performed by any suitable API or software.

As described above, the system may additionally and/or alternatively establish photo properties, which may include establishing keywords. The application may launch a content detection application programming interface, API. The step of analyzing the at least one image file may then further comprise labelling the image file with at least one identifying term based on the content detected by the content detection API.

### Photo Recommendation Engine

The photo recommendation engine 470 may display interest-based profile photos 437 of users 410 to user 410A. The photo recommendation engine 470 may be implemented using any suitable combination of hardware, firmware, and software. The photo recommendation engine 470 may be a software module stored in memory 445 and executed by processor 440. An example algorithm for photo recommendation engine 470 is as follows: (1) receive request to receive photo recommendations by user 410A; (2) analyze characteristics of user 410A (e.g., as embodied in user profile 430A); (3) analyze photo properties of interest-based profile photos 437; (4) based on characteristics of user 410A and photo properties of interest-based profile photos 437, determine to display interest-based profile photos to user 410A. In short, relevant photos are displayed to user 410A. Another example algorithm for photo recommendation is as follows: (1) receive request to receive photo recommendations by user 410A; (2) analyze characteristics of user 410A (e.g., user profile 430A); (3) analyze characteristics of other users 410 (e.g. other user profiles 430); (4) based on characteristics of user 410A and other users 410, determine to display interest-based profile photos corresponding to relevant users 410 to user 410A. In short, photos from relevant users are displayed to user 410A. Yet another example algorithm for photo recommendation is as follows: (1) receive request to receive photo recommendations by user 410A; (2) analyze characteristics of user 410A (e.g., user profile 430A); (3) analyze characteristics of other users 410 (e.g. other user profiles 430); (4) analyze photo properties of interest-based profile photos 437 corresponding to relevant users 410; (5) based on characteristics of user 410A and photo properties of interest-based profile photos 438, determine to display interest-based profile photos to user 410A. In short, relevant photos from relevant users are displayed to user 410A. While the above examples present possible algorithms for photo recommendation engine 470, this disclosure contemplates that photo recommendation engine 470 may use any algorithm operable to facilitate recommending photos to users 410. For example, the algorithm used by photo recommendation engine 470 may include modifications, additions, or omission to the example algorithm presented above. Furthermore, the algorithm used by photo recommendation engine 470 may include more, fewer, or other steps as compared with the example algorithm presented above, and the steps may be performed in parallel or in any suitable order.

The photo recommendation engine 470 displays interest-based profile photos 437 to users 410. After displaying interest-based profile photos 437, the photo recommendation engine 470 may receive preference indications for the photos. The photo recommendation engine 470 may rely on various parameters to determine that interest-based profile photos 437 should be displayed to user 410. For example, photo recommendation engine 470 may analyze information included in user 410A's user profile 430 such as user data 432 (e.g. information regarding what user 410 may be looking for in recommendations or matches), user interests 434 (e.g. keywords of interest), user photo profile 436, user interaction history, or any other suitable information. If user 410B receives from user 410A a positive preference for a photo corresponding to user 410B, user 410B may seek to establish communication with user 410A through communication engine 480. The communication engine 480 may provide different types of interactions for users 410 as will be described in further detail below.

The photo recommendation engine 470 may consider any number of factors to determine which photos to display to users 410. As an example, photo recommendation engine 470 employs a machine-learning algorithm trained to generate ranked lists of photos to display to user 410A based on user data 432 and/or user interest 434 of user 410.

The photo recommendation engine 470 may determine how closely one user's preferences match another user's characteristics and vice versa. The photo recommendation engine 470 may be configured to generate a pool of potential matching users for user 410A according to various characteristics and preferences of user 410A and other users of the system. The photo recommendation engine 470 may assign scores to the pool of potential matching users for user 410A based on preferences and/or activity of user 410A. The photo recommendation engine 470 may also restrict entities from being included in the pool of potential recommended users based on the status of the profile, location information regarding the entity, or location information regarding user 410A. Upon identifying a pool of matching users 410, photo recommendation engine will display one or more interest-based profile photos 437 corresponding to users 410.

The photo recommendation engine 470 may determine how closely interest-based profile photos of one user matches another user's user interests. The photo recommendation engine 470 may be configured to generate a pool of recommended interest-based profile photos 437 for user 410A according to user's user data, user interests, and/or user interaction history. The photo recommendation engine 470 may assign scores to the pool of potential recommended interest-based profile photos 437. The photo recommendation engine 470 may also restrict certain interest-based profile photos 437 from being included in the pool of potential recommended interest-based profile photos 437 based on the interest-based profile photo's photo properties or keywords or the status of the user 410 associated with the interest-based profile photo 437 (e.g., location information, blocked, etc.).

The photo recommendation engine may recommend interest-based profile photos to user 410A without taking into account relevance of the interest-based profile photo to user 410A. The photo engine may recommend an interest-based profile photo because the interest-based profile photo 437 is a promoted photo or associated with a promoted user (e.g. a user who paid a higher fee structure). The photo recommendation may recommend an interest-based profile photo based on its other photo properties including, for example, its popularity or freshness. The photo recommendation engine may recommend an interest-based profile photo completely at random. The photo recommendation engine may recommend a photo that is a sponsored photo (e.g. an advertisement).

The photo recommendation engine may cycle through any of the above approaches. For example, photo recommendation engine may show an interest-based profile photo from a matching user followed by an interest-based profile photo having relevant properties followed by a sponsored photo followed by an interest-based profile photo ranking highly in popularity and so on.

The photo-based matching tool 405 may receive from user 410A a preference indication for interest-based profile photo 437 belonging to user 410B. The preference indication may include a positive preference indication (e.g., LIKE or SUPERLIKE or clicking onto a user's photo profile), a negative preference indication (e.g., NOPE), an unsure indication, a rating, a score (e.g., a numerical score), a pass indication (e.g., PASS), or no indication at all. This preference indication may be used to update user data 432 and/or user interests 434 (interests in the case of a positive preference, and disinterests in the case of a negative preference, unsure, pass, and/or no indications). Such preference indication may be a prerequisite for engaging in a communication via communication engine.

As described above, it is important to note that photo recommendation engine may over time recommend multiple interest-based profile photo 437 belonging to user 410B to user 410A so that user 410B has multiple shots on goal to showcase various facets of their personality to user 410A.

Other techniques may be used to determine the presented photos. For example, photos belonging to users 410 that have been presented previously may be excluded or deprioritized. As another example, photos belonging to users 410 that have been blocked by user 410A may also be excluded. As yet another example, photos belonging to users 410 that have already received a positive preference from user 410A may also be excluded. A combination of these techniques as well as others may be used to determine the limited number of entities presented to user 410A.

### Communication Engine

There are many ways to enable communication between users within matching, networking, and social services, any of which may be used in the system of the present invention.

The present invention contemplates that a first user 410A may receive interest from other users 410 via the photo-based matching tool 405. Upon receiving interest from other users 410, the first user may initiate communication with the other users 410 via communication engine 480. The communication may be any experience where users 410 may engage with each other. Such communication may encompass any combination of short and/or long text messages, voice messages, video messages, and images, configured to carry substantive communication/information from one user to one or more other users. The electronic messages/mail are (typically personally) composed by the user transmitting the electronic messages/mail. Either user can terminate a communication at any time. Moreover, after users have initiated communication, either user is free to “block” the other user should they wish to do so. Once either user blocks the other user, it is no longer possible for either of those users to communicate with the other via the dating app.

The communication engine 480 may decide to end a communication. The communication engine 480 may determine to end a communication based on information from user 410. For example, user 410 may request that communication end, exit the system and/or an application on device 415 implementing communication engine 480, etc.

The communication engine 480 may add information related to a communication or interaction history to user profile 430. The communication engine 480 may add information such as keywords of messaged photos. The communication engine 480 may analyze communication text to determine user interests.

A particular feature of the system of the present invention is that certain types of communication may be prohibited or delayed. For example, messaged photos may be prohibited for an initial period of time of communication, herein referred to as locked period. This allows users to lead with their personalities in these interactions, rather than relying on, for example, sending photos of users' looks. Additionally, this discourages nefarious users who use such systems for the purposes of spamming other users (for example, with lewd or explicit photos).

There may be multiple locked periods prohibiting sending of different types of communication. For example, after an initial locked period is terminated, users may be enabled to send only messaged photos which are substantially absent of human faces. After a further locked period is terminated, users may be enabled to send messaged photos which do include human faces. At this stage, preventing messaged photos containing content forbidden by the particular locked period may be achieved by the photo processing engine.

A locked period may be terminated by various means. For example, a locked period may be terminated after a predetermined threshold (e.g. time, number of messages) has elapsed. As another example, a locked period may be terminated upon request as further described below. A combination of the foregoing may be used (e.g. only after a predetermined threshold, such as 38 hours, can a request to terminate be initiated).

With respect to termination of a locked period by request, either user in the communication can initiate a request to the other user to terminate a locked period. For example, it may be user 410A who initiates the request to user 410B. If user 410B does not accept the request, but rejects or ignores it instead, the locked period continues to prevent the locked communication type.

Preferably, each of the users is only permitted to send a limited number of such requests, up to a request threshold, for example a maximum of three requests to terminate the locked period. Accordingly, if user 410A attempts to send another such request, communication engine 480 determines whether user 410A reached the request threshold. If not, a further request is instigated to user 410B; if so, no further request is sent because user 410A is not permitted to send any more requests to user 410B, at least at the current point in time. User 410A may be informed of this via the user interface of their application. This may be an absolute limit, whereby user 410A is never allowed to send another request to user 410B, or it may be time limited, whereby earlier requests are discounted for the purposes of imposing this limit once an appropriate amount of time has elapsed, for example.

Each request may also have a limited time interval in which it can be accepted, after which it expires. Once user 410A's request has expired, user 410B can no longer accept it; however, user 410B is free to send their own request to user 410A, which user 410A can accept if they choose.

During the locked period, users may send photos that are part of their respective user photo profiles 436. During the locked period, users may send photos absent of human faces, and optionally, further absent of other impermissible features. On the one hand, this still provides the aforementioned benefits described above, but on the other hand does so whilst providing a more engaging conversation experience as there is still an engaging visual component of the communication event before the locked period is terminated.

### Additional Features

Another problem that has arisen in matching, networking, and social services, for example an online dating service, is that users may eventually stop using the service, either temporarily or permanently. While their accounts remain active on the system, these accounts are effectively ghost accounts. This poses the problem that active users will continue to come across these ghost accounts and seek to interact with these ghost accounts. Over time upon failed interactions with ghost accounts, active users may become unsatisfied with the system. While it is possible to shut these ghost accounts down based on inactivity, inactive users may later choose to return to the service.

The present invention contemplates that the interest-based profile photos 437 may have an expiration date. An expired interest-based profile photo 437 will be removed from corresponding user photo profile 436. As a user becomes inactive, their interest-based profile photos 437 will all eventually expire. As described above, the photo-based recommendation engine makes recommendations based on interest-based profile photos. To the extent all of a user's interest-based profile photos are expired, the user will be unable to participate in the system. Subsequently, active users will not come across inactive users.

A further advantage to interest-based profile photos having an expiration date is that users 410 will continue to upload new photos over time. As described above, the photo recommendation engine will only display a photo no more than once to each user. By uploading new photos upon expiration of old ones, a user 410 will have multiple opportunities to be connected with other users 410 who have already seen their previous photos.

The system 400 may be configured to provide gamification. For example, the system 400 may be configured to monitor when a user 410 achieves certain goals, such as level of engagement in communication engine 480 or amount of time spent using the system 400 and, subsequently, provide an achievement badge. As another example, the system 400 may be configured to monitor the popularity of an interest-based profile photo 437 of user 410 and, where the interest-based profile photo achieves a popularity score above a certain threshold, provide an achievement badge. As yet another example, the system 400 may be configured to monitor keywords associated with photos uploaded by a user 410 and, subsequently, provide a badge corresponding to that tag (e.g. a “musician” badge for a user that uploads numerous photos of musical instruments or an “animal friend” badge for a user that uploads numerous photos of their pet). These badges may be displayed in a variety of locations, for example, on the page depicting user photo profile 436 or on an interest-based profile photo 437 as it is displayed by the photo recommendation engine 470. An advantage to this is that users 410 may be more engaged in the system 400.

The user profile 430 of user 410 may include a component accessible by other users that is an music or song that is representative of the personality of the user 410. This may further help the user represent their interests and personality without disclosing their looks.

The system 400 may include a free mode and a premium mode. For example, the user 410 may pay a subscription (weekly, monthly, annual, biannual, lifetime) to access all premium features. As an example, advertisements may not be displayed to premium users. Additionally and/or alternatively, the user 410 may pay to unlock specific premium features. The user 410 may pre-purchase credits with which to unlock specific premium features as needed. Specific premium features may be unlocked multiple times in various contexts (e.g. unlocked on a per match basis).

The system 400 may include advertisements. It is typical for social media and dating applications to include advertisement to generate revenue. Notably, the system 400 may be particularly advantageous for advertisements. As discussed herein, user profiles in traditional dating applications include photos depicting users' faces. As users in these traditional dating applications scroll or swipe through such profile photos depicting other users' faces, an advertisement depicting something other than a face, for example, dog toys or coffee will be jarring and thus annoying to the user. However, in the system 400 of the invention wherein all the profile photos depict subject matter other than users' faces, such advertisements will be less jarring. Additionally, as each user 410 will have a user profile 430 comprising user interest 434, advertisement in the system 400 can be targeted very specifically to relevant users.

Modifications, additions, or omissions may be made to the systems described herein without departing from the scope of the invention. For example, system 400 may include any number of users 410, devices 415, networks 420, and databases 425. The components may be integrated or separated. Moreover, the operations described above may be performed by more, fewer, or other components. For example, although described as photo-based matching tool 405, photo recommendation engine 470, communication engine 480, and photo processing engine 460 performing certain operations, any component in system 400 may perform these operations. Additionally, the operations may be performed using any suitable logic comprising software, hardware, or other logic.

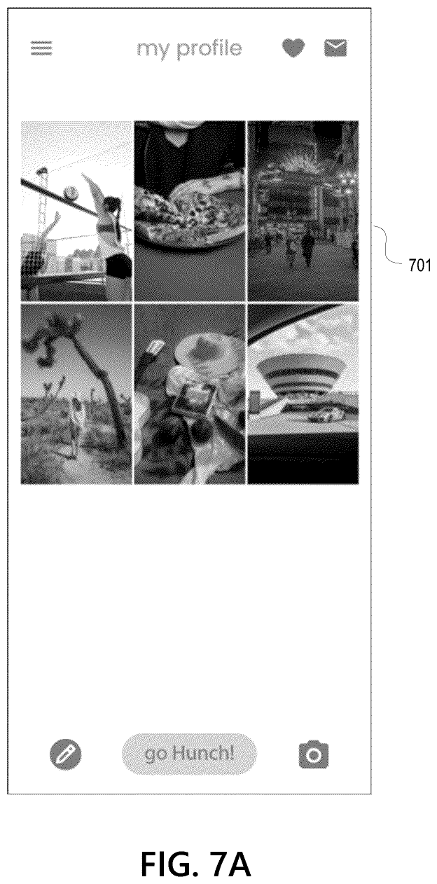

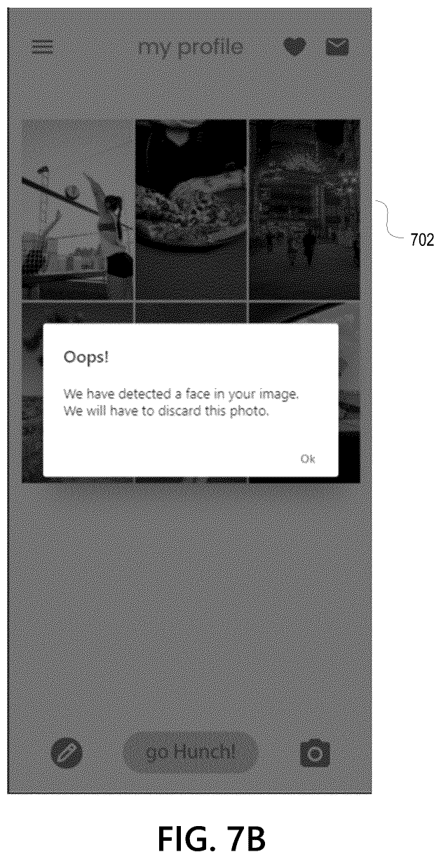

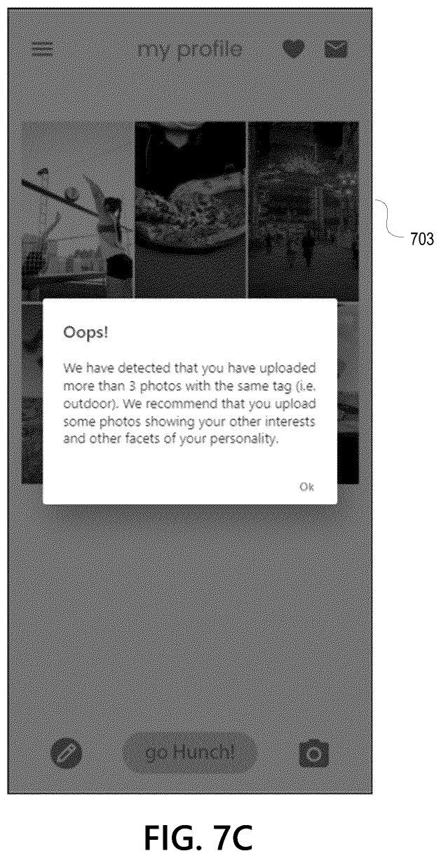

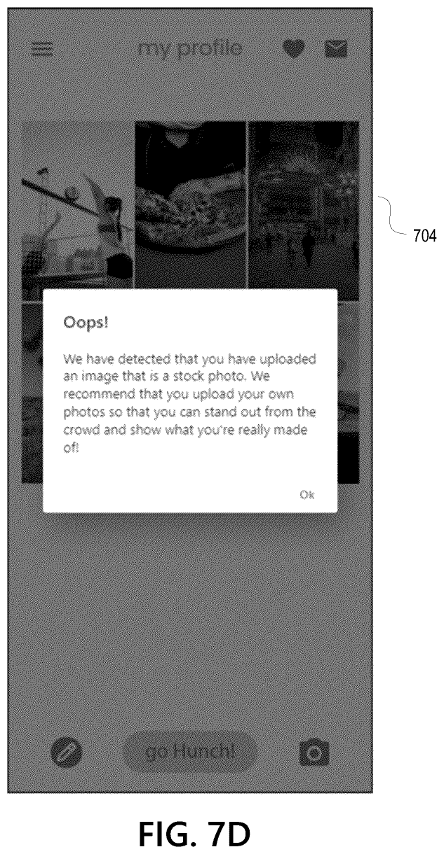

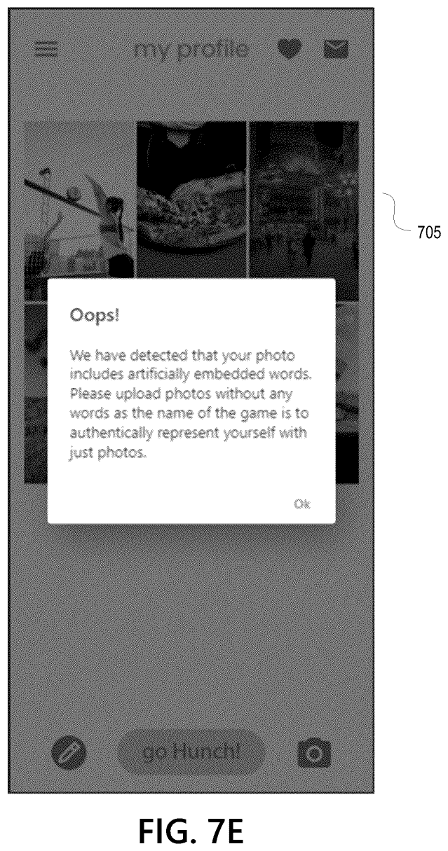

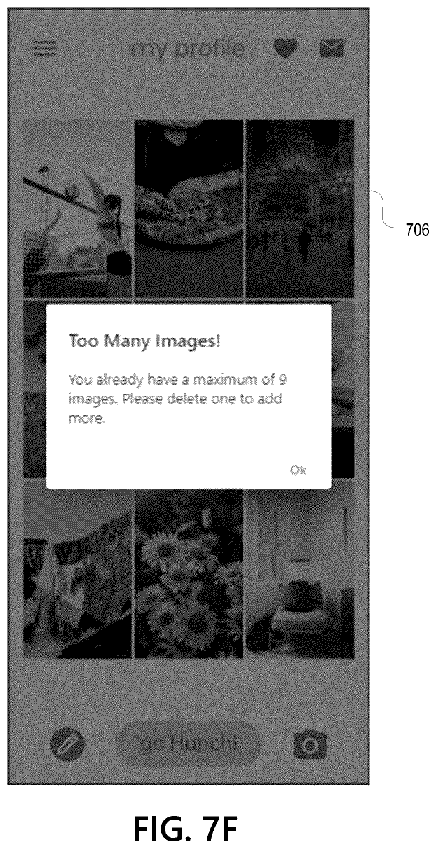

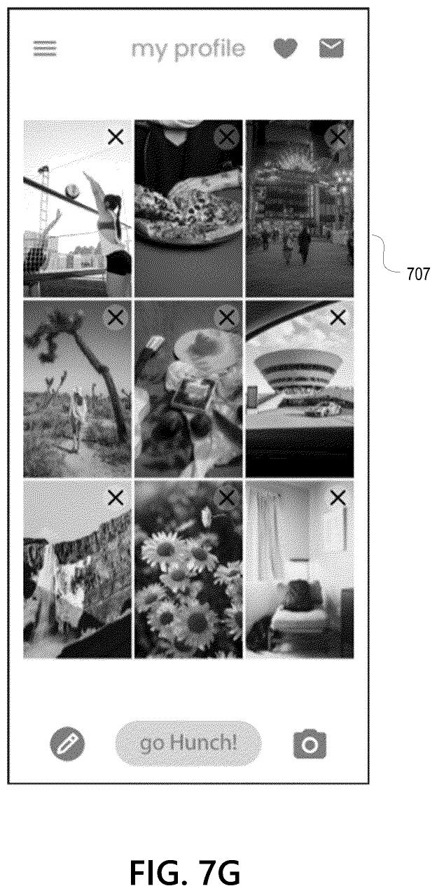

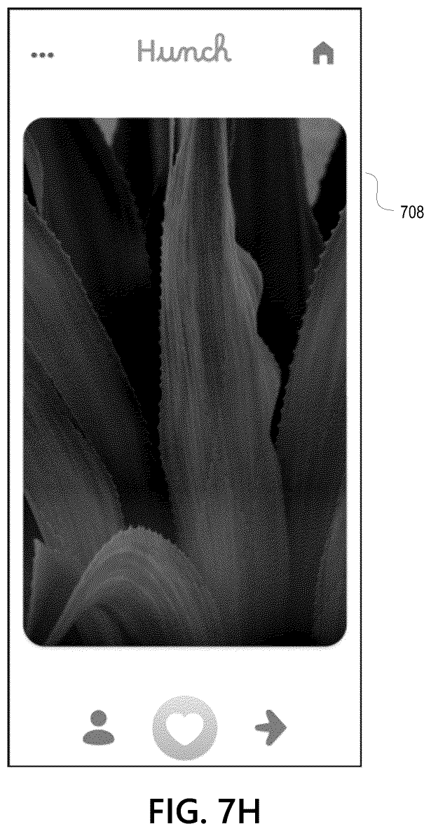

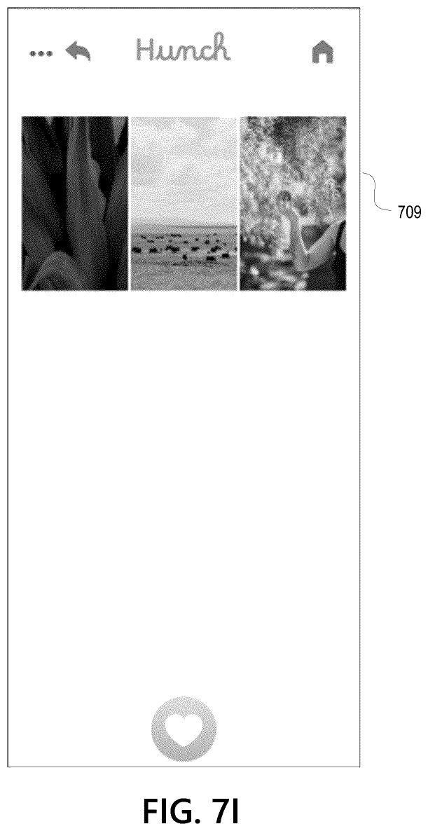

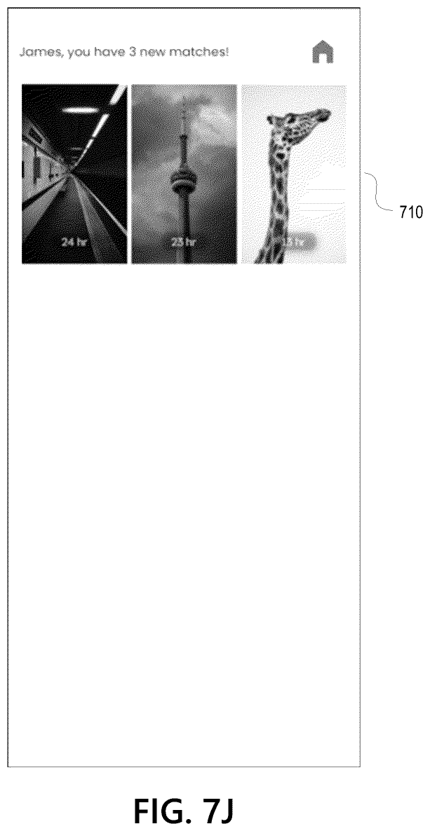

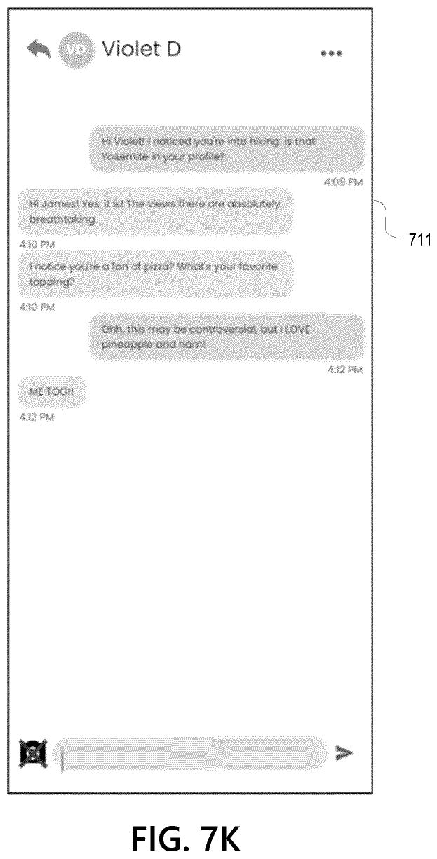

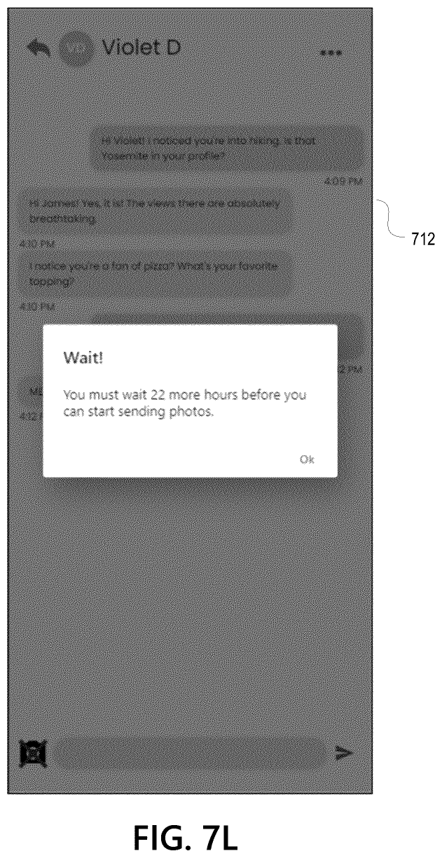

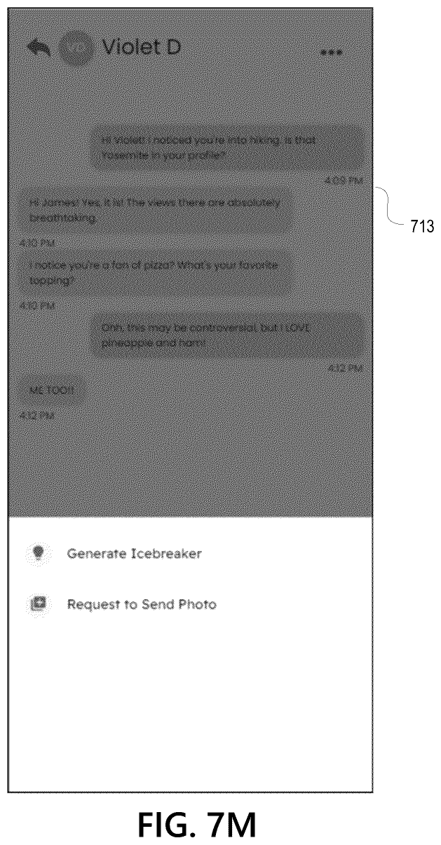

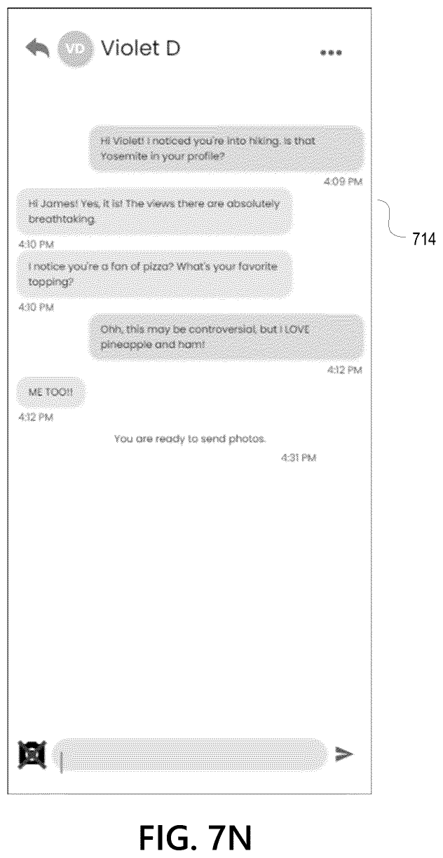

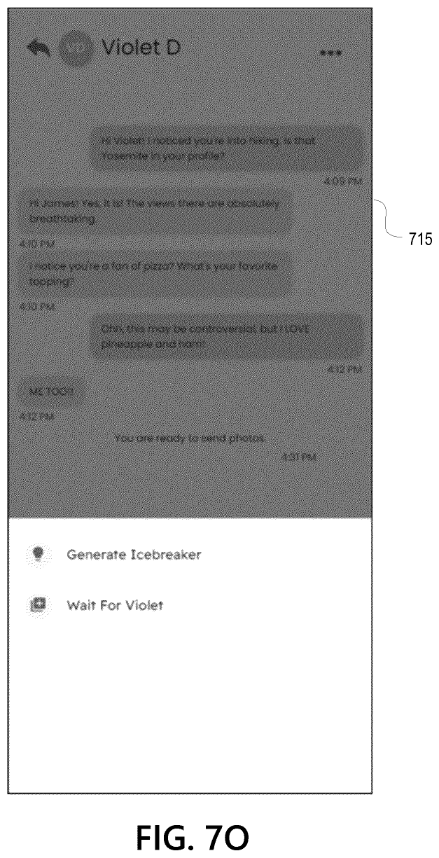

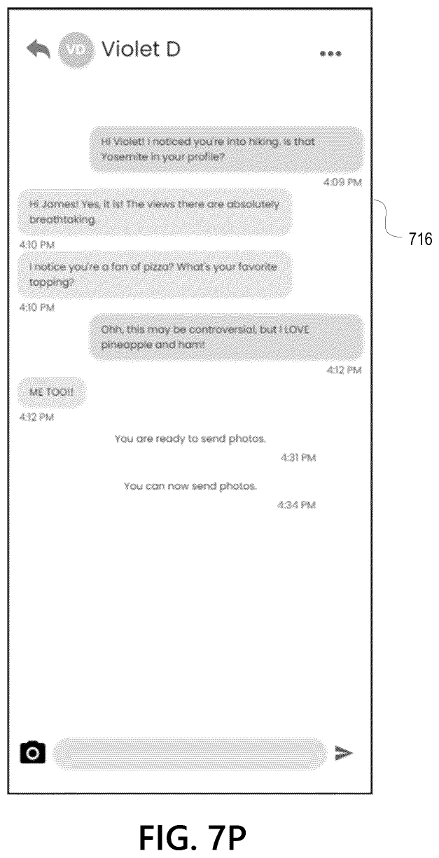

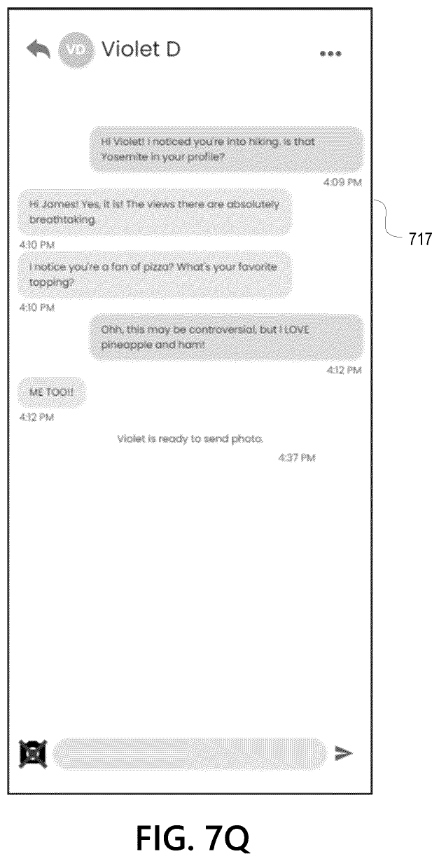

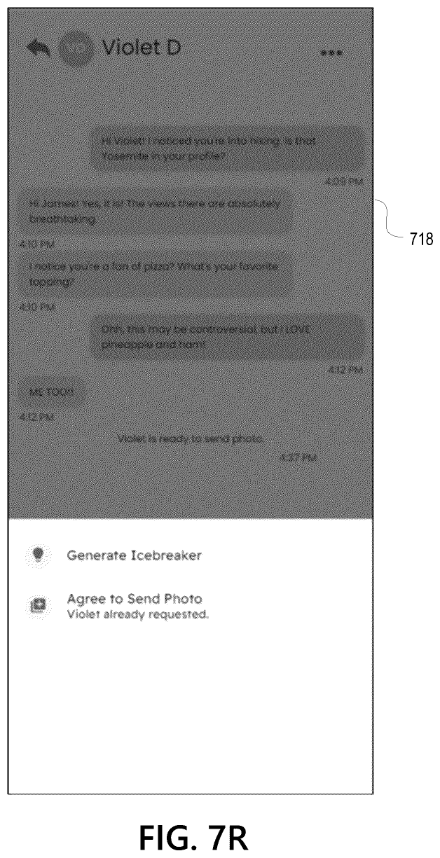

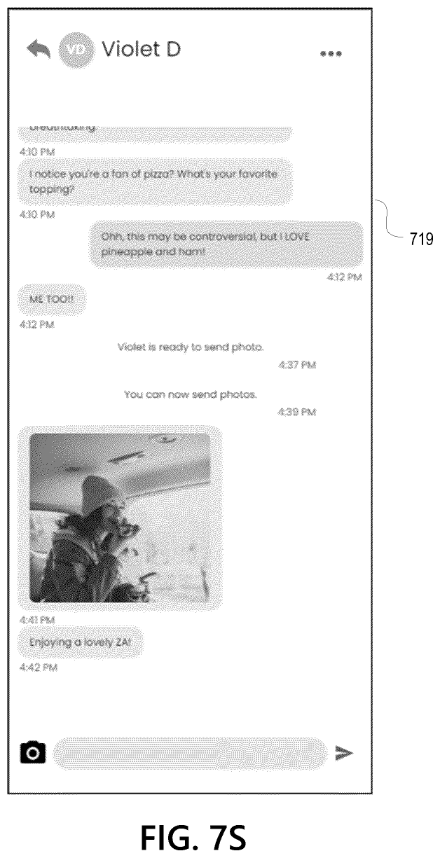

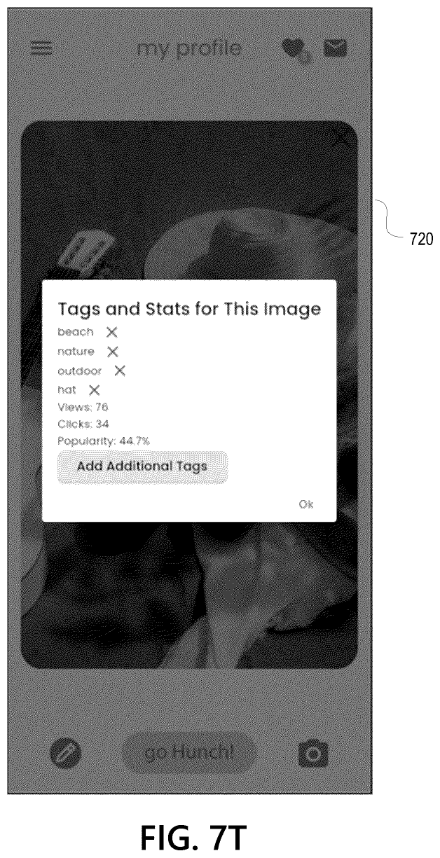

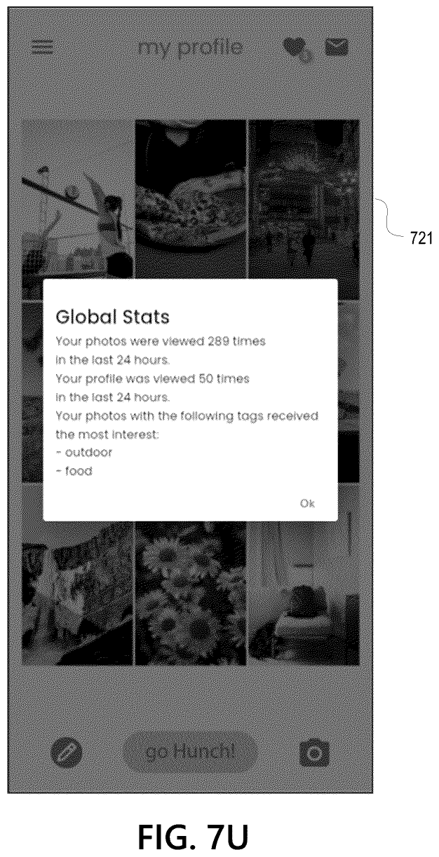

FIG. 7A shows a social media application user interface 701 depicting a profile. Seven user-uploaded images are shown, and none depict any faces. These images depict interests such as volleyball, pizza, concerts, and the like. In turn, keywords for such images might be “volleyball,” “food,” “pizza,” “concerts,” “music,” “travel,” and the like.

FIG. 7B shows a social media application user interface depicting a notification 702 preventing uploading of a photo with a face. This notification might be output as part of step 306 of FIG. 3 where, for example, a human face was detected as part of step 303 of FIG. 3.

FIG. 7C shows a social media application user interface depicting a notification 703 preventing uploading of a photo too similar to previously-uploaded photos. This notification might be output as part of step 306 of FIG. 3 where, for example, a substantially similar picture was detected as part of step 304 of FIG. 3.

FIG. 7D shows a social media application user interface depicting a notification 704 preventing uploading of a stock photo. This notification might be output as part of step 306 of FIG. 3 where, for example, an image was found on a database as part of step 305 of FIG. 3.

FIG. 7E shows a social media application user interface depicting a notification 705 preventing uploading of a photo including embedded words. This notification might be output as part of step 306 of FIG. 3 where, for example, words were detected during processing of the first image as described with respect to step 302 of FIG. 3.

FIG. 7F shows a social media application user interface depicting a notification 706 preventing uploading of too many photos. In some cases, users might be limited to uploading a predetermined number of photos at any time. The notification 706 might be output in circumstances where the user purports to upload a number of images that exceed a threshold.

FIG. 7G shows a social media application user profile editing user interface 707. As indicated by the “X” buttons on each image, a user might be able to delete already-uploaded images from their user profile as desired. Here, it is also possible to swap positions of already-uploaded images.

FIG. 7H shows a social media application user interface 708 depicting a second user's profile, with a particular focus on a single image. In many cases, users might be presented with only a single image of another user's profile. In other words, while a user (such as the user 410A) might upload a plurality of different photos, other users might only see a single image. As indicated above, this means that other users might have multiple opportunities to match with that user, as they might be presented different images from the same user profile at different times. If a user does like a photo, the user might indicate positive interest (e.g., by right-swiping, clicking on a heart icon, or the like). In contrast, if the user does not like the photo, the user might indicate negative interest (e.g., by left-swiping, hitting a “next” button, or the like). This is the circumstance depicted in FIG. 7H. Additionally and/or alternatively, users might be presented with a collage of multiple images from another user's profile as depicted in FIG. 7I. For example, if a user in interested in an image, they might choose to see a collage of all of the user's photos (e.g., by clicking on an icon, or the like).

FIG. 7I shows a social media application user interface 709 depicting a second user's profile by presenting a collage of multiple images from the second user's profile. This allows the first user the opportunity to view and assess additional facets of the second user's interests and personality. If upon viewing this collage, the first user does like the second user, the first user might indicate positive interest (e.g. by clicking on a heart icon, or the like).

FIG. 7J shows a social media application matches listing 710. The indications of times (e.g., “23 hr”) on each image represent the time which the user has to message another user. For example, upon matching with a second user, a first user might have to initiate contact within twenty-four hours. This may ensure that both users communicate quickly and are actively engaged in the process.

FIG. 7K shows a social media application user interface depicting a communications session 711 between two users. The users are, in the example depicted in FIG. 7J, permitted to exchange text communications. As observed in the communication between illustrative users James and Violet, they are able to talk about each other's interest and depicted by photos in their respective user profiles. Additionally or alternatively, the communication between James and Violet may be driven by conversation starters or ice breakers recommended by an artificial intelligence algorithm based on the users' respective interest-based profile photos and corresponding keywords. However, as indicated by the “X” over the camera icon, are not permitted to share photos in the communication session as this time. In this manner, the users cannot exchange personal photos until later in the chat process.

FIG. 7L shows a social media application user interface depicting a notification 712 preventing a user from sending photos to another user within a predetermined period of time. As indicated above, users might be prevented from sharing photos via a communications session for a predetermined period of time. In this manner, the users cannot exchange personal photos until later in the chat process and are, in effect, encouraged to engage on an emotional level.

FIG. 7M shows a social media application user interface depicting a set of options 713 for a first user. The options include the ability to request to send a second user photos (e.g., to expedite the time limit referenced above with respect to FIG. 7K) and/or the request to generate an ice breaker (e.g., automatically generate a prompt using shared keywords).

FIG. 7N shows a social media application user interface depicting a communications session 714 between two users. Following a first user's request to send the second user photos as in FIG. 7M, the communications sessions depicts the first user's request.

FIG. 7O shows a social media application user interface depicting a set of options 715 for a first user. Following the first user's request to send the second user photos as in FIG. 7M, the option instead now notes that the first user must wait for the second user.

FIG. 7P shows social a media application user interface depicting a communications session 716 between two users. Following a first user's request to send the second user photo as in FIG. 7M and acceptance by the second user, the communication session depicts that the users may now send photos.

FIG. 7Q shows a social media application user interface depicting a communications session 717 between two users. Following a second user's request to send the first user photos, the communication session depicts the second user's request.

FIG. 7R shows a social media application user interface depicting a set of options 718 for a first user. Following a second user's request to send the first user photos, the option instead now notes that the first user must agree to send photos.

FIG. 7S shows a social media application user interface depicting a communication session 719 between two users. Following a second user's request to send the first user photos and acceptance by the first user, the communication session depicts that the users may now send photos. Subsequently and for the first time, the second user is able to send to the first user a photo depicting her facial appearance.

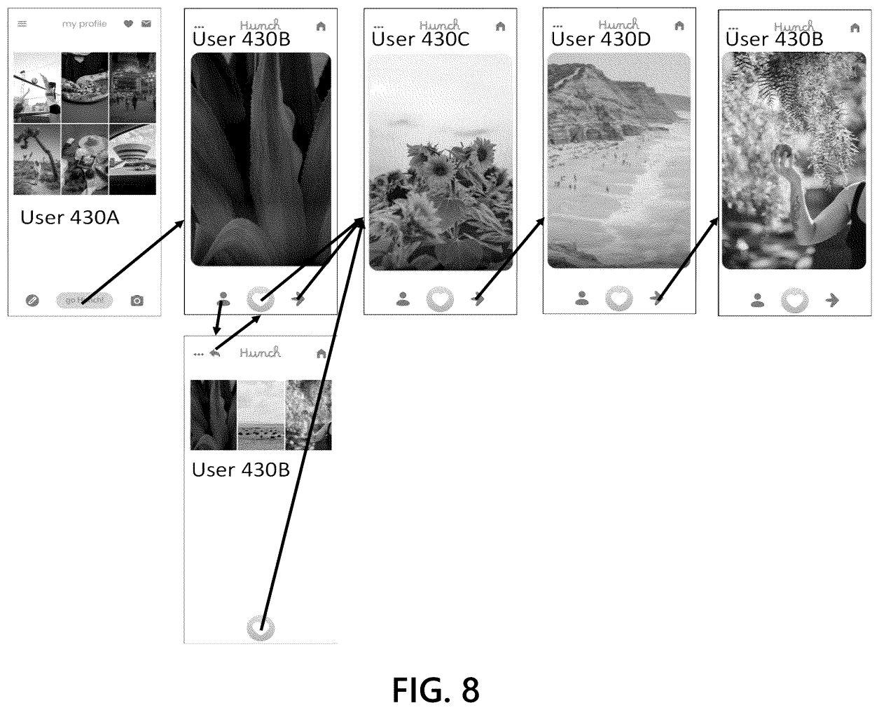

FIG. 8 depicts an illustrative example of a first user 430A navigating the social media application user interface and receiving images associated with other users. As illustrated, the first user 430A receives an image associated with a second user 430B. At this point, the first user 430A may choose to see a collage of all the images associated with the second user 430B. As the first user 430A proceeds (e.g. by expressing interest), the first user 430A may receive an image associated with a third user 430C. As the first user 430A proceeds (e.g. by expressing no interest), the first user 430A may receive an image associated with a third user 430D. As the first user 430A proceeds, the first user 430A may receive a different image associated with the second user 430B. In this regard, the user 430B has multiple shots on goal to pique the interest of the first user 430A.

FIG. 7T shows a social media application user interface depicting a listing 720 of keywords and statistics for a particular image. In some circumstances, users might be informed of the keywords identified for a particular image as well as metadata for the images such as the number of views of the image, the number of clicks of the image, and a popularity of the image (e.g., the number of users that clicked the image out of the number of users that viewed the image). These statistics might be particularly interesting for users because, as indicated above, in some circumstances users might only be presented a single image from a user profile when prompted to match with a user. In other words, because other users might respond to a single image when indicating positive or negative interest, their responses to those images might be tracked and analyze to help determine which image(s) are particularly popular and not popular. This information may, in turn, be used to help advise users regarding whether images should be changed (e.g., removed). For example, if a substantial majority of users continually indicate a negative response towards a particular interest (e.g., a photo of poorly-cooked food), then the social media application might prompt the user to replace that image to improve their chances of matching.

FIG. 7U shows a social media application user interface depicting global statistics 721 for a particular user. The global statistics 721 may indicate, for example, a total number of photo views for a user profile, a total number of user profile views, and the popularity of various tags.

While the above has been predominantly described in the context of online dating, the invention is not so limited. Thus, online matching using progressive capture of prospect information may be employed within employment activities such as matching an employer and job seeker; shopping activities, including but not limited to shopping for autos, travel, real estate, and the like; fantasy sports games such as matching potential players or the like; group matching such as matching groups with a potential member; small business matching, such as a supplier with a buyer or the like. Thus, the invention is not to be limited to the examples described above.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method to implement a dating application comprising:
receiving, by a computing device, a first image to be associated with a first user profile corresponding to a first user; and
based on determining that the first image does not contain any human faces, storing the first image as part of a first user profile.

2. The method of claim 1, further comprising:
determining, by the computing device and based on one or more objects in the first image, one or more first keywords;
storing, by the computing device and as part of the first user profile and as part of the first image, the one or more first keywords;
querying, by the computing device and based on the one or more first keywords, a database to identify one or more of:
a second image, wherein the second image is associated with a second user profile; or
the second user profile; and
displaying, by the computing device and in a user interface, the second image.

3. The method of claim 2, wherein the second image corresponds to a subset of one or more second keywords associated with the second user profile, and wherein none of the subset of the one or more second keywords are the same as the one or more first keywords.

4. The method of claim 2, wherein the second image corresponds to a subset of one or more second keywords associated with the second user profile, and wherein the one or more first keywords and the subset of the one or more second keywords both comprise a shared keyword.

5. The method of claim 2, wherein the storing the first image is further based on determining that the first image does not contain any words.

6. The method of claim 2, further comprising:
receiving a third image to be associated with the first user profile corresponding to the first user; and
based on comparing the one or more first keywords and one or more third keywords of the third image:
causing output, in the user interface, of a notification that the third image will not be added to the first user profile.

7. The method of claim 2, further comprising:
preventing the first user from uploading a third image based on determining that the third image contains at least one human face.

8. The method of claim 2, further comprising:
generating, based on one or more second keywords associated with the second user profile, a discussion prompt for the first user and the second user; and
causing display, in the user interface, of the discussion prompt.

9. The method of claim 2, wherein displaying the second image associated with the second user profile comprises:
displaying, at different times, different images of the second user profile.

10. The method of claim 1, wherein the storing the first image is further based on:
sending the first image to a reverse image search engine; and
receiving, from the reverse image search engine, an indication that the first image has not been uploaded on a website.

11. A computing device configured to implement a dating application, the computing device comprising:
one or more processors, and
memory storing instructions that, when executed by the one or more processors, cause the computing device to:
receive a first image to be associated with a first user profile corresponding to a first user; and
based on determining that the first image does not contain any human faces, store the first image as part of a first user profile.

12. The computing device of claim 11, wherein the instructions, when executed by the one or more processors, cause the computing device to:
determine, based on one or more objects in the first image, one or more first keywords;
store, by the computing device and as part of the first user profile and as part of the first image, the one or more first keywords;
query, by the computing device and based on the one or more first keywords, a database to identify one or more of:
a second image, wherein the second image is associated with a second user profile; or
the second user profile; and
display, by the computing device and in a user interface, the second image.

13. The computing device of claim 12, wherein the second image is associated with a subset of one or more second keywords, and wherein none of the subset of the one or more second keywords are the same as the one or more first keywords.

14. The computing device of claim 12, wherein the second image is associated with a subset of one or more second keywords, and wherein the one or more first keywords and the subset of the one or more second keywords both comprise a shared keyword.

15. The computing device of claim 12, wherein the instructions, when executed by the one or more processors, cause the computing device to:
receive a third image to be associated with the first user profile corresponding to the first user; and
based on comparing the one or more first keywords and one or more third keywords of the third image:
cause output, in the user interface, of a notification that the third image will not be added to the first user profile.

16. One or more non-transitory computer-readable media storing instructions that, when executed by one or more processors of a computing device, cause the computing device to implement a dating application by causing the computing device to:
receive a first image to be associated with a first user profile corresponding to a first user; and
based on determining that the first image does not contain any human faces, store the first image as part of a first user profile.

17. The one or more non-transitory computer-readable media of claim 16, wherein the instructions, when executed by the one or more processors, cause the computing device to:
determine, based on one or more objects in the first image, one or more first keywords;
store, by the computing device and as part of the first user profile and as part of the first image, the one or more first keywords;
query, by the computing device and based on the one or more first keywords, a database to identify one or more of:
a second image, wherein the second image is associated with a second user profile; or
the second user profile; and
display, by the computing device and in a user interface, the second image.

18. The one or more non-transitory computer-readable media of claim 17, wherein the second image is associated with a subset of one or more second keywords, and wherein none of the subset of the one or more second keywords are the same as the one or more first keywords.

19. The one or more non-transitory computer-readable media of claim 17, wherein the second image is associated with a subset of one or more second keywords, and wherein the one or more first keywords and the subset of the one or more second keywords both comprise a shared keyword.

20. The one or more non-transitory computer-readable media of claim 17, wherein the instructions, when executed by the one or more processors, cause the computing device to:
receive a third image to be associated with the first user profile corresponding to the first user; and
based on comparing the one or more first keywords and one or more third keywords of the third image:
cause output, in the user interface, of a notification that the third image will not be added to the first user profile.
